(19) United States
(12) Patent Application Publication
(10) Pub. No.: US 2025/0154671 A1
(43) Pub. Date: May 15, 2025

(54) PERMSELECTIVE GAS DIFFUSION ELECTRODE

(71) Applicant: UTI LIMITED PARTNERSHIP, Calgary (CA)

(72) Inventors: Md Golam KIBRIA, Calgary, AB (CA); George K. H. SHIMIZU, Calgary, AB (CA); Nedal N. MAREI, Calgary, AB (CA); Tareq A. AL-ATTAS, Calgary, AB (CA); Shariful Kibria NABIL, Calgary, AB (CA)

(21) Appl. No.: 18/838,431

(22) PCT Filed: Feb. 14, 2023
(86) PCT No.: PCT/CA2023/050190

§ 371 Date: Aug. 14, 2024

Related U.S. Application Data
(60) Provisional application No. 63/310,007, filed on Feb. 14, 2022.

(51) Int. Cl. C25B 11/032; B01D 53/32; B01D 53/86; C25B 1/23; C25B 11/054; C25B 11/089

(52) U.S. Cl. CPC C25B 11/032; B01D 53/326; B01D 53/864; B01D 53/8671; C25B 1/23; C25B 11/054; C25B 11/089; B01D 2255/20761; B01D 2257/502; B01D 2257/504; B01D 2258/0283

(57) ABSTRACT

Permselective gas diffusion electrodes (PGDE) for electrocatalytic reduction of CO₂ and/or CO·CO₂- or CO-selective mixed matrix membranes (MMM) to facilitate enhanced permeance of CO₂ or CO, respectively, into the PGDE facilitate electrocatalytic reduction of CO₂ or CO. Permselective MMM include a filler of intrinsic nanopores (FINs) which can be a metal organic framework (MOF), activated carbon (AC), zeolite or covalent organic framework (COF)) that exhibits selective adsorption of CO₂ or CO. An alkaline flow cell or membrane electrode assembly for CO₂ or CO reduction which comprises a permselective PGDE is also provided. Further provided are methods of separating CO₂ from CO₂-containing gases for electrochemical reduction of CO₂. Also provided are methods of separating CO from CO-containing gases for electrochemical reduction of CO. Also provided are methods for electrocatalytic reduction of CO₂ and/or CO to produce C₂₊ products.

### BACKGROUND

The disclosure relates generally to gas diffusion electrodes that are useful for integrated separation and/or capture of CO₂ or CO and electrochemical conversion of CO₂ or CO. The devices and methods herein are of particular application to the separation and/or capture and conversion of CO₂ or CO from gas streams having low concentrations of these gases. The devices and methods herein are more specifically useful for capture of CO₂ from flue gas.

Increasing concentrations of carbon dioxide (CO₂) in the atmosphere is a significant challenge. Industrial activities have contributed to the rapid accumulation of such greenhouse gas emissions. CO₂ capture is a viable approach to decrease carbon emissions from industrial point sources. Post-combustion carbon capture is efficient because it requires minimal retrofitting for existing point sources. Post-combustion carbon capture via aqueous monoethanolamine (MEA), ethylenediamine (EDA), methyldiethanolamine (MDEA), and decylamine (DCA) solutions have been successfully scaled up in the industry. (Sanz-Pérez, E. S.; Murdock, C. R.; Didas, S. A.; Jones, C. W. Direct Capture of CO₂ from Ambient Air. Chem. Rev. 2016, 116 (19), 11840-11876) There have also been several attempts for integrated carbon capture and conversion by electrochemically utilizing CO₂-loaded capture solutions. The electrochemical conversion of CO₂-rich alkanolamines solutions of MEA, EDA, and DCA provided a potential route to sidestep the conventional regeneration stage of amine-based carbon capture technologies. Large scale application of such electrochemical conversions is hindered by low electrolyzer and catalyst stability due to the corrosive nature of amine-based solutions, mass transfer limitations due to the high viscosity of the amines, and high energy demand resulting in high operating costs.

Integration of aqueous hydroxide-based direct air (carbon) capture (DAC) technologies with (bi) carbonate electrolysis to produce fuels would bypass the energy-intensive solvent regeneration and CO₂ pressurization stages of the DAC systems. However, the feasibility of large-scale DAC integrated with (bi) carbonate electrolysis is problematic due to low faradaic efficiency, high cell voltage (>3V), limited mechanistic and kinetic understanding, and high capital and operating costs.

Direct electrochemical reduction reactions of CO₂ gas (CO₂RR) has been regarded as a promising strategy to obtain high-value products and concomitantly offset CO₂ emissions. (Liu, A.; Gao, M.; Ren, X.; Meng, F.; Yang, Y.; Gao, L.; Yang, Q.; Ma, T. Current Progress in Electrocatalytic Carbon Dioxide Reduction to Fuels on Heterogeneous Catalysts. J. Mater. Chem. A 2020, 8 (7), 3541-3562.) However, most studies on CO₂RR are dedicated to pure CO₂ streams, while high-concentration streams from point source emitters represent only 2.6% of the total CO₂ released annually (Table 1). The power sector alone emits about 85% of the total CO₂ released from industrial point sources. However, it usually releases flue gases with CO₂ concentrations of ˜10%. (National Petroleum Council Report “Meeting the Dual Challenge,” Volume II, Chapter Two: “CCUS Supply Chains and Economics’, available at dualchallenge.npc.org.) The current cost of purifying CO₂ from diluted flue gas streams is in the range of $70-$275 per ton of CO₂ purified. It is thus important to develop cost-effective capture technologies from dilute CO₂ streams or develop CO₂RR reactors that operate and are tolerant to CO₂ streams of low concentration. There is thus significant interest in the art for a cost-effective electrolyzer that operates via direct intake of low CO₂ concentration gas streams, such as flue gas as the CO₂RR feedstock. (Xu, Y.; Edwards, J. P.; Zhong, J.; O'Brien, C. P.; Gabardo, C. M.; McCallum, C.; Li, J.; Dinh, C. T.; Sargent, E. H.; Sinton, D. Oxygen-Tolerant Electroproduction of C2 Products from Simulated Flue Gas. Energy Environ. Sci. 2020, 13 (2), 554-561; Kim, B.; Ma, S.; Molly Jhong, H. R.; Kenis, P. J. A. Influence of Dilute Feed and PH on Electrochemical Reduction of CO₂ to CO on Ag in a Continuous Flow Electrolyzer. Electrochim. Acta 2015, 166, 271-276.)

TABLE 1
CO₂ concentration and total annual emission for point sources.

| | CO₂ in | Total Annual |
|---|---|---|
| | Exhaust | emission |
| Facility Type | (%) | (MMtCO₂) |
| Natural Gas Processing | 95-100 | 47.24 |
| Ethanol Production | 95-100 | 19.65 |
| Ammonia Production | 95-100 | 35.72 |
| Hydrogen Production | 45 | 45.59 |
| Cement Plants | 21 | 66.84 |
| Refinery Fluidized Catalytic Cracking | 16 | — |
| (FCC) Plants | | |
| Steel/Iron Plants | 26 | 75.74 |
| Coal Power Plants | 13 | 912.68 |
| Industrial Furnaces (refining/chemicals) | 8 | — |
| Natural Gas Power Plants | 4 | 47.24 |

The present disclosure provides permselective gas diffusion layers employing a filler of intrinsic nanopores (FINs), including metal organic framework (MOF), activated carbon (AC), zeolite or covalent organic framework (COF)) that exhibit selective adsorption of CO₂ on the gas feed side of a gas diffusion electrode to form a CO₂ permselective gas diffusion electrode for use in electrochemical reduction of CO₂.

As an example, metal-organic frameworks (MOFs) have increasingly been viewed as viable candidates for membrane-based gas separation because they can overcome plasticisation and the selectivity/permeability trade-off associated with traditional polymeric membranes. (Venna, S. R.; Carreon, M. A. Metal Organic Framework Membranes for Carbon Dioxide Separation. Chem. Eng. Sci. 2015, 124, 3-19; Rui, Z.; James, J. B.; Kasik, A.; Lin, Y. S. Metal-Organic Framework Membrane Process for High Purity CO₂ Production. AlChE J. 2016, 62 (11), 3836-3841; Robeson, L. M. The Upper Bound Revisited. J. Memb. Sci. 2008, 320 (1-2), 390-400; Koros, W. J.; Mahajan, R. Pushing the Limits on Possibilities for Large Scale Gas Separation: Which Strategies? J. Memb. Sci. 2001, 181 (1), 141.)

Although pure MOF membranes have been reported to show high separation selectivity, they are mechanically fragile which render them susceptible to cracking during synthesis and processing. (Qian, Q.; Asinger, P. A.; Lee, M. J.; Han, G.; Mizrahi Rodriguez, K.; Lin, S.; Benedetti, F. M.; Wu, A. X.; Chi, W. S.; Smith, Z. P. MOF-Based Membranes for Gas Separations. Chem. Rev. 2020, 120 (16), 8161-8266.) Incorporating MOFs as dispersed FINs within a continuous polymer matrix to form porous, particularly nanoporous, mixed matrix membranes (MMMs) is an alternative to overcome issues of mechanical stability, while maintaining high separation performance under industrially relevant feed conditions. (Qian, Q.; Asinger, P. A.; Lee, M. J.; Han, G.; Mizrahi Rodriguez, K.; Lin, S.; Benedetti, F. M.; Wu, A. X.; Chi, W. S.; Smith, Z. P. MOF-Based Membranes for Gas Separations. Chem. Rev. 2020, 120 (16), 8161-8266; Trickett, C. A.; Helal, A.; Al-Maythalony, B. A.; Yamani, Z. H.; Cordova, K. E.; Yaghi, O. M. The Chemistry of Metal-Organic Frameworks for CO₂ Capture, Regeneration and Conversion. Nat. Rev. Mater. 2017, 2 (8), 1-16.). To the knowledge of the inventors, FINs including MOF-containing mixed matrix membrane (MMM) have not been employed to generate permselective gas diffusion electrodes, and particularly not for CO₂ reduction.

Carbon monoxide (CO) is one of the primary constituents of industrial waste gas streams (steel processing plants or thermal power plants; 0-40% concentration). The electrochemical CO reduction reaction (CORR) has thus recently received attention because of its better selectivity for conversion to specific chemicals than that of CO₂ reduction reaction (CO₂RR). Carbon monoxide (CO) is an intermediate of electrochemical CO₂ reduction for higher order hydrocarbon formation. Thus, the systems, methods and materials herein also enable CO as primary reduction feedstock in place of CO₂. A number of major CO reduction reaction (CORR) products have been identified including various C₂ hydrocarbons, e.g., ethane, ethylene, acetylene, and C₂ oxygenates, acetic acid, and ethanol, which are also common products from CO₂ reduction. Particularly under alkaline conditions utilizing polycrystalline copper or analogous catalysts, CO reduction generates major products similar to CO₂ reduction including among others, methane, ethylene, ethanol, propanol, acetic acid. This is possible due to large decrease of overpotential for CO reduction compared to that for CO₂ reduction which allows for higher C—C coupling under similar operating conditions. This emphasizes the importance of CO as the key reaction intermediate in CO₂ reduction and use of CO as feedstock rather than CO₂ for production of C₂₊ (two carbon and higher) reduced products. The type of products formed from CORR also depends on choice and fabrication of the catalyst. In general, bi or tri-metallic catalysts like Cu doped with other functional elements, including among others Ag, and Ru can generate higher carbon alcohols and oxygenates including n-propanol, acetaldehyde and acetate. Cu single atom or dual atomic catalyst can produce ethylene while morphologically shaped catalysts (e.g., triangular, fragmented) can generate acetate and propanol. Hierarchical nano-range Cu catalysts can produce n-propanol and other liquid oxygenated products. An important step to producing multi-carbon (C₂₊) products in the CORR is believed to be the coupling of two C₁ intermediates to form a C—C bond. The generation of C₃ products from CO requires multiple product/intermediate formation steps and is complicated by the competing production of a wide variety of chemical products. The low C₃ selectivity on Cu catalysts is attributed to the low rate of C—C bond formation, and the competition of C₁-C₁ and C₁-C₂ couplings. The negatively charged *CO dimer is a believed to be a common precursor for the formation of ethylene, ethanol, and n-propanol. (H. J. Peng, M. T. Tang, J. Halldin Stenlid, X. Liu, F. Abild-Pedersen, Trends in oxygenate/hydrocarbon selectivity for electrochemical CO(₂) reduction to C₂ products. Nat. Commun. 13, 1-11 (2022); Y. Ji, A. Guan, G. Zheng, Copper-based catalysts for electrochemical carbon monoxide reduction. Cell Reports Phys. Sci. 3, 101072 (2022); L. Wang, S. A. Nitopi, E. Bertheussen, M. Orazov, C. G. Morales-Guio, X. Liu, D. C. Higgins, K. Chan, J. K. Nørskov, C. Hahn, T. F. Jaramillo, Electrochemical Carbon Monoxide Reduction on Polycrystalline Copper: Effects of Potential, Pressure, and pH on Selectivity toward Multicarbon and Oxygenated Products. ACS Catal. 8, 7445-7454 (2018))

### SUMMARY

In one aspect, the invention provides a permselective gas diffusion electrode (PGDE) for electrocatalytic reduction of CO₂ which contains a mixed matrix membrane (MMM) to facilitate enhanced permeance of CO₂ into the PGDE. In an embodiment, MMM exhibits selectivity for adsorption of CO₂ relative to adsorption of N₂, O₂ or both of 2-fold or more. The CO₂-adsorption selective MMM has a gas-feed side and a reaction side. The reaction side of the MMM is in fluid communication with or in direct contact with an electrically conductive CO₂ reduction catalyst layer. When operated for CO₂ reduction, the PGDE is in fluid communication with a CO₂-containing gas, the electrically conductive CO₂ reduction catalyst layer is in fluid communication with an electrolyte and electrically connected to a potential source. In embodiments, the electrically conductive CO₂ reduction catalyst layer provides the working electrode of the PGDE. In embodiments, the electrically conductive CO₂ reduction catalyst layer is provided as a layer or coating on the working electrode of the PGDE.

In embodiments, the CO₂-adsorption selective MMM is a free-standing or supported layer providing CO₂-selective permeance in the PGDE. In this embodiment, the electrically conductive CO₂ reduction catalyst layer is in direct contact with the reaction side of the MMM. In embodiments, the electrically conductive CO₂ reduction catalyst layer is provided as a layer or coating on the reaction side of the MMM.

In embodiments, the PGDE also contains a gas diffusion layer (GDL) distinct from the MMM. The GDL has a gas-feed side and a reaction side. In embodiments, the MMM is provided as a layer or coating on the gas-feed side of the gas diffusion layer, and the electrically conductive CO₂ reduction catalyst is provided as a layer or a coating on the reaction side of the gas diffusion layer.

In embodiments, the MMM comprises a polymer matrix with an inorganic or organic FINs that exhibits CO₂-selective adsorption dispersed in the polymer matrix. In embodiments, the inorganic or organic FINs is uniformly dispersed in the polymer matrix.

In embodiments, the MMM contains an inorganic or organic material that exhibits CO₂-selective adsorption. In embodiments, the MMM contains a metal organic polyhedral (MOP) or metal organic framework (MOF as a FINs. In embodiments the MMM contains a covalent organic framework (COF) as a FINs. In embodiments, the MMM contains carbonaceous material (e.g., activated carbon) as a FINs. In embodiments, the MMM contains a zeolite as a FINs. In embodiments the MMM is a MOF-MMM. To be specific, in embodiments, the MOF is a Zn-MOF. In embodiments, the MOF is CALF-20.

In embodiments, the MMM contains a structured organic material that exhibits CO₂-selective adsorption. In embodiments, the MMM contains a porous organic framework (POF).

In embodiments, the CO₂ reduction catalyst is a metal, metal alloy, metal oxide or combination thereof that catalyzes reduction of CO₂ to CO. In embodiments, the CO₂ reduction catalyst comprises Cu, Ag, Au, Fe, Sn, or Pd. In embodiments, the CO₂ reduction catalyst is a layer or coating of Ag. In embodiments, the CO₂ reduction catalyst is a metal, metal alloy, metal oxide or a combination thereof that promotes reduction of CO₂ to form methanol or formic acid. In embodiments, the CO₂ reduction catalyst is a metal, metal alloy, metal oxide or a combination thereof that promotes reduction of CO₂ to form reduction products that contain multiple carbon atoms, such as ethylene, ethanol, acetic acid and the like. In embodiments, the CO₂ reduction catalyst comprises Cu. In embodiments, the CO₂ reduction catalyst is a layer or coating of Cu, a copper oxide or a combination thereof.

In embodiments, the CO₂ reduction catalyst is a MOF. In embodiments, the CO₂ reduction catalyst is a Zn-MOF. In embodiments, the CO₂ reduction catalyst is CALF-20 or ZIF-8.

In embodiments, where the products of CO₂-reduction are preferably C₂₊ products, the CO₂ reduction catalyst is preferably a catalyst comprising copper. In such embodiments, the catalyst is preferably selected from polycrystalline copper, a bi or tri-metallic catalyst containing copper doped with other functional elements including Ag, Ru, a Cu single atom or dual atomic catalyst, a morphologically shaped copper catalysts (e.g., triangular, fragmented) or a hierarchical nano-range Cu catalyst.

In embodiments, the PGDE contains a gas diffusion layer which is modified to enhance CO₂-permeation by providing a mixed matrix membrane (MMM) layer on the gas-feed side of the gas diffusion layer, wherein the MMM layer comprises a selected loading of an inorganic or structured organic filler that itself exhibits CO₂-selective adsorption. In embodiments, the MMM exhibits CO₂-selective adsorption relative to N₂, O₂ or both of at least 2-fold. In embodiments, the MMM exhibits CO₂-selective adsorption relative to N₂, O₂ or both of at least 5-fold. In embodiments, the MMM exhibits CO₂-selective adsorption relative to N₂, O₂ or both of at least 10-fold. In embodiments, the inorganic filler is a MOF that exhibits selective permeation of CO₂ relative to N₂, O₂ or both. In embodiments, an electrically conductive CO₂ reduction catalyst layer is provided in contact with the reaction side of the gas diffusion layer. In embodiments, the MOF in the MMM is CALF-20.

The invention also provides an electrolyzer including a membrane electrode assembly or alkaline/neutral/acidic flow cell for CO₂ reduction which comprises a PGDE of the disclosure. In the electrolyzer, the PGDE provides the cathode of the device. In embodiments of these devices, the MMM of the PGDE is in fluid communication with a CO₂-containing gas, which includes a flue gas or a post-combustion flue gas. In embodiments of these devices, the CO₂ reduction catalyst is in fluid communication with CO₂ permeating the PGDE and in fluid communication with an electrolyte, and more specifically a catholyte. In embodiments of these devices, a material, which may be a gas or liquid, to be oxidized is provided at the anode of the device. Application of a selected potential across the cathode and anode of the device results in reduction of CO₂ (and in embodiments CO) and concomitant oxidation of the material to be oxidized. The material to be oxidized can be water, H₂, any oxidizable organic substance, or a combination thereof. In embodiments the material to be oxidized can include an alcohol, a diol, a triol, a polyol, a sugar, a sugar alcohol, an olefin, an aldehyde, particularly furfural or a substituted furfural, such as hydroxymethylfurfural or a combination of any of the foregoing. In embodiments, the CO₂-reduction product is CO. In embodiments, the CO₂-reduction product is methanol or formic acid (formate). In embodiments, the CO₂-reduction product is a product or mixture of products containing 2 or more carbons. In more specific embodiments, the disclosure provides a gas diffusion electrode (GDE) containing a mixed matrix membrane (MMM) layer which comprises a polymer and a metal organic framework material (MOF), wherein the MOF exhibits selective adsorption of CO₂ relative to N₂, O₂ or both. In embodiments, the MOF-MMM layer functions as a CO₂-selective gas diffusion layer in GDE. In this case, a conductive CO₂ reduction catalyst (CO₂RR) layer is provided in contact with the reaction side of the MOF-MMM in the GDE which also functions as the electrode in the GDE. In embodiments, the GDE comprises a gas diffusion layer other than an MOF-MMM, and the gas diffusion layer is modified to enhance CO₂-permeation by providing the MOF-MMM layer on the gas-feed side of the gas diffusion layer. In this embodiment, a conductive CO₂ reduction catalyst layer is provided in contact with the reaction side of the gas diffusion layer. In embodiments, the MOF-MMM gas diffusion layer or the modified gas diffusion layer exhibits selectivity for permeation of CO₂ relative to permeation of N₂, O₂ or both of 2-fold or more.

In a second aspect, the invention provides a permselective gas diffusion electrode (PGDE) for electrocatalytic reduction of CO which contains a mixed matrix membrane (MMM) to facilitate enhanced permeance of CO into the PGDE. In an embodiment, MMM exhibits selectivity for adsorption of CO relative to adsorption of N₂, O₂ or both of 2-fold or more. In an embodiment, MMM exhibits selectivity for adsorption of CO relative to adsorption of CO₂ of 2-fold or more. The CO-adsorption selective MMM has a gas-feed side and a reaction side. The reaction side of the MMM is in fluid communication with or in direct contact with an electrically conductive CO reduction catalyst layer. When operated for CO reduction, the PGDE is in fluid communication with a CO-containing gas, the electrically conductive CO reduction catalyst layer is in fluid communication with an electrolyte and electrically connected to a potential source. In embodiments, the electrically conductive CO reduction catalyst layer provides the working electrode of the PGDE. In embodiments, the electrically conductive CO reduction catalyst layer is provided as a layer or coating on the working electrode of the PGDE. In embodiments, the Co permselective gas diffusion electrode (PGDE) can be used to separate CO from gas streams containing low concentrations of CO.

In embodiments, the CO-adsorption selective MMM is a free-standing or supported layer providing CO-selective permeance in the PGDE. In this embodiment, the electrically conductive CO reduction catalyst layer is in direct contact with the reaction side of the MMM. In embodiments, the electrically conductive CO reduction catalyst layer is provided as a layer or coating on the reaction side of the MMM.

In embodiments, the PGDE also contains a gas diffusion layer (GDL) distinct from the MMM. The GDL has a gas-feed side and a reaction side. In embodiments, the MMM is provided as a layer or coating on the gas-feed side of the gas diffusion layer, and the electrically conductive CO reduction catalyst is provided as a layer or a coating on the reaction side of the gas diffusion layer.

In embodiments, the MMM comprises a polymer matrix with an inorganic or organic FINs that exhibits CO-selective adsorption dispersed in the polymer matrix. In embodiments, the inorganic or organic FINs is uniformly dispersed in the polymer matrix.

In embodiments, the MMM contains an inorganic or organic material that exhibits CO-selective adsorption. In embodiments, the MMM contains a metal organic polyhedral (MOP) or metal organic framework (MOF as a FINs. In embodiments the MMM contains a covalent organic framework (COF) as a FINs. In embodiments, the MMM contains carbonaceous material (e.g., activated carbon) as a FINs. In embodiments, the MMM contains a zeolite as a FINs. In embodiments the MMM is a MOF-MMM. In embodiments, the MMM contains a structured organic material that exhibits CO-selective adsorption. In embodiments, the MMM contains a porous organic framework (POF).

In embodiments, the CO reduction catalyst is a metal, metal alloy, metal oxide or combination thereof that catalyzes reduction of CO₂ to CO. In embodiments, the CO reduction catalyst comprises Cu, Ag, Au, Fe, Sn, or Pd. In embodiments, the CO reduction catalyst is a layer or coating of Ag. In embodiments, the CO reduction catalyst is a metal, metal alloy, metal oxide or a combination thereof that promotes reduction of CO to form methanol or formic acid. In embodiments, the CO reduction catalyst is a metal, metal alloy, metal oxide or a combination thereof that promotes reduction of CO to form reduction products that contain multiple carbon atoms, such as ethylene, ethanol, acetic acid and the like. In embodiments, the CO reduction catalyst comprises Cu. In embodiments, the CO reduction catalyst is a layer or coating of Cu, a copper oxide or a combination thereof.

In embodiments, the CO reduction catalyst is a MOF. In embodiments, the CO reduction catalyst is a Zn-MOF. In embodiments, the CO reduction catalyst is CALF-20 or ZIF-8.

In embodiments, where the products of CO-reduction are preferably C₂₊ products, the CO reduction catalyst is preferably a catalyst comprising copper. In such embodiments, the catalyst is preferably selected from polycrystalline copper, doped with nanoporous carbon, a bi or tri-metallic catalyst containing copper doped with other functional elements including Ag, Pb, Pd, Fe, Au, Ru, a Cu single atom or dual atomic catalyst, chemically functionalized or 3D interconnected copper (e.g., oxide derived) and morphologically shaped copper catalysts (e.g., triangular, fragmented) or a hierarchical nano-range Cu catalyst.

In embodiments, the PGDE contains a gas diffusion layer which is modified to enhance CO-permeation by providing a mixed matrix membrane (MMM) layer on the gas-feed side of the gas diffusion layer, wherein the MMM layer comprises a selected loading of an inorganic or structured organic filler that itself exhibits CO-selective adsorption. In embodiments, the MMM exhibits CO-selective adsorption relative to N₂, O₂ or both of at least 2-fold. In embodiments, the MMM exhibits CO-selective adsorption relative to N₂, O₂ or both of at least 5-fold. In embodiments, the inorganic filler is a MOF that exhibits selective permeation of CO relative to N₂, O₂ or both. In embodiments, the inorganic filler is a MOF that exhibits selective permeation of CO relative to CO₂. In embodiments, an electrically conductive CO reduction catalyst layer is provided in contact with the reaction side of the gas diffusion layer.

The invention further provides an electrolyzer including a membrane electrode assembly or alkaline/neutral/acidic flow cell for CO reduction which comprises a PGDE of the disclosure. In the electrolyzer, the PGDE provides the cathode of the device. In embodiments of these devices, the MMM of the PGDE is in fluid communication with a CO-containing gas. In embodiments, the CO-containing gas also contains N₂, O₂ or both. In embodiments, the CO-containing gas contains CO₂. In embodiments the CO-containing gas contains 10% or more by volume of CO. In embodiments, the CO-containing gas contains less than 5% by volume CO₂. In an embodiment the CO-containing gas contains less than 1% by volume CO₂. In an embodiment the CO-containing gas contains less than 0.5% by volume CO₂.

In embodiments of these devices, the CO reduction catalyst is in fluid communication with CO permeating the PGDE and in fluid communication with an electrolyte, and more specifically a catholyte. In embodiments of these devices, a material, which may be a gas or liquid, to be oxidized is provided at the anode of the device. Application of a selected potential across the cathode and anode of the device results in reduction of CO (and possibly CO₂ that may be present) and concomitant oxidation of the material to be oxidized. The material to be oxidized can be water, H₂, any oxidizable organic substance, or a combination thereof. In embodiments the material to be oxidized can include an alcohol, a diol, a triol, a polyol, a sugar, a sugar alcohol, an olefin, an aldehyde, particularly furfural or a substituted furfural, such as hydroxymethylfurfural or a combination of any of the foregoing. In embodiments, the CO-reduction product is methane. In embodiments, the CO-reduction product is methanol or formic acid (formate). In embodiments, the CO-reduction product is a product or mixture of products containing 2 or more carbons (C₂₊).

In more specific embodiments, the disclosure provides a gas diffusion electrode (GDE) containing a mixed matrix membrane (MMM) layer which comprises a polymer and a metal organic framework material (MOF), wherein the MOF exhibits selective adsorption of CO relative to N₂, O₂ or both. In embodiments, the MOF-MMM layer functions as a CO-selective gas diffusion layer in GDE. In this case, a conductive CO reduction reaction catalyst (CORR) layer is provided in contact with the reaction side of the MOF-MMM in the GDE which also functions as the electrode in the GDE. In embodiments, the GDE comprises a gas diffusion layer other than an MOF-MMM, and the gas diffusion layer is modified to enhance CO-permeation by providing the MOF-MMM layer on the gas-feed side of the gas diffusion layer. In this embodiment, a conductive CO reduction catalyst layer is provided in contact with the reaction side of the gas diffusion layer. In embodiments, the MOF-MMM gas diffusion layer or the modified gas diffusion layer exhibits selectivity for permeation of CO relative to permeation of N₂, O₂ or both of 2-fold or more. In embodiments, the MOF-MMM gas diffusion layer or the modified gas diffusion layer exhibits selectivity for permeation of CO relative to permeation of CO₂.

In another aspect, the invention provides a permselective gas diffusion electrode (PGDE) for electrocatalytic reduction of CO₂ essentially to CO wherein the PGDE contains a mixed matrix membrane (MMM) to facilitate enhanced permeance of CO₂ into the PGDE. In embodiments, when operated for CO₂ reduction, the PGDE is in fluid communication with a CO₂-containing gas, the electrically conductive CO₂ reduction catalyst layer is in fluid communication with an electrolyte and electrically connected to a potential source. In embodiments, the CO₂ reduction catalyst is selective for reduction to CO. In specific embodiments, the CO₂ reduction catalyst selective for reduction of CO₂ to CO is Ag, Pb, or Au which are particularly selective and efficient towards CO₂ to CO formation. In embodiments, the electrically conductive CO₂ reduction catalyst layer provides the working electrode of the PGDE. In embodiments, the electrically conductive CO₂ reduction catalyst layer is provided as a layer or coating on the working electrode of the PGDE. The CO produced in electrocatalytic reduction of CO₂ is then used as feedstock in the reduction of CO. In specific embodiments, the CO produced by electrocatalytic reduction of CO₂ is used for electrocatalytic reduction of CO to form C₂₊ carbon products. In embodiments, CO₂ is reduced in an alkaline flow cell or membrane electrode assembly containing the CO₂ permselective PGDE to form CO as the at least predominant product of reduction. In an embodiment, this process is a two step process, where CO exits the alkaline flow cell or membrane electrode assembly containing the CO₂-permselective PGDE and is thereafter reduced to one or more desired C₂₊ products. In a further embodiment, the CO produced is catalytically reduced to one or more desired C₂₊ product. In a further embodiment, the CO produced is electrocatalytically reduced to one or more desired C₂₊ product. In an embodiment, the CO is electrocatalytically reduced to one or more desired C₂₊ product employing an alkaline flow cell or membrane electrode assembly containing a CO-permselective PGDE. In specific embodiments, selective reduction of CO to C₂₊ products employs a catalyst selected from polycrystalline copper optionally doped with nanoporous carbon; a bi or tri-metallic catalyst containing copper doped with other functional elements including Ag, Pb, Pd, Fe, Au, Ru or a combination thereof; a Cu single atom or dual atomic catalyst optionally chemically functionalized, 3D interconnected copper (e.g., oxide derived), morphologically shaped copper catalysts (e.g., triangular, fragmented) or a hierarchical nano-range Cu catalyst.

Other aspects and embodiments of this disclosure will be readily apparent to one of ordinary skill in the art on review of the detailed descriptions, drawings and non-limiting examples herein.

### BRIEF DESCRIPTION OF THE DRAWINGS

FIG. 1. A schematic representation of the concentration profile of the downstream flue gas permeating through a CO₂-selective membrane then dissolving in the double-phase boundary of catalyst layer-electrolyte. P_{d,CO}_{₂} and P_{d,N}_{₂} are the downstream partial pressures of CO₂ and N₂ after permeating the CO₂-selective membrane, while C_{CO}_{₂} and CN₂ are the concentrations of CO₂ and N₂ in the liquid electrolyte.

FIGS. 2A and 2B. (A) A schematic showing the adsorption-diffusion mechanism in gas membrane separation. P_{u,CO}_{₂}, P_{u,N}_{₂} and P_{u,O}_{₂} are the upstream partial pressures of CO₂, N₂ and O₂. P_{d,CO}_{₂}, P_{d,N}_{₂} and P_{d,O}_{₂} are the downstream partial pressures of CO₂, N₂ and O₂. The dashed line represents the start of the boundary layer. (B) A schematic representation of the permselective gas diffusion electrode (PGDE) showing the MOF-based mixed matrix membrane (MMM) on the gas feed side and sputtered Ag on the reaction side, which are separated by polytetrafluoroethylene-based (PTFE) gas diffusion layer. Molecules are illustrated very large relative to the PGDE for the sake of illustration.

FIGS. 3A and 3B. Chemical structure of (A) Zinc oxalate dehydrate and (B) 1,2,4-Triazole, (C) 3d representation of CALF-20 framework.

FIG. 4. Schematic illustration of the crystal structure of CALF-20; including the chemical structure of the polyhedron zinc nodes.

FIGS. 5A and 5B. (A) CO₂, N₂, O₂ and CO isotherms at 298 K on pure CALF-20. (B) Drop of partial pressure for CO₂ and N₂ across PGDE.

FIGS. 6A-6E. Material characterizations of an exemplary PGDE. (A) and (B) Cross-section scanning electron microscopy (SEM) image and corresponding energy-dispersive X-ray spectroscopy (EDX-) image (right) of Ag and Zn for the Ag/PTFE/MMM PGDE. Ag: yellow, C: red and Zn: turquoise. (C) SEM image of the MMM side of the PGDE. (D) SEM image of Ag side of the PGDE, (E) Fourier-transform infrared (FTIR) spectra of CALF-20, fluoropolymer resin and CALF-20-sulfonated fluoropolymer resin (CALF-20-MMM).

FIGS. 7A-7D. (A) Cross-section scanning electron microscopy (SEM) and (B) corresponding energy-dispersive X-ray spectroscopy (EDX) image of the Ag/PTFE electrode. (C/D) Scanning electron microscopy (SEM) of the Ag side of the PGDE (C, 5 micron scale; D, 500 nm scale).

FIG. 8. FTIR spectra of CALF-20, the sulfonated fluoropolymer resin (designated Nafion®) and CALF-20-sulfonated fluoropolymer (MMM).

FIGS. 9A and 9B. (A) Multimeric (polymeric) intermolecular hydrogen-bonding between fluoropolymer molecules (commercially available under the trademark Nafion®). (B) Dimeric intermolecular hydrogen-bonding between the fluoropolymer resin molecules (Nafion®) and 1,2,4-triazole.

FIGS. 10A-10C. Effect of having the MMM as a CO₂-selective permeating layer. (A) A schematic of the electrochemical cell. (B) Faradaic efficiencies of CO at different loadings of CALF-20 in the MMM layer at −1.32 V_{RHE}. (C). Faradaic efficiencies of CO, H₂ and corresponding current densities were obtained at different applied potentials on the Ag/PTFE and PGDE (7 mg cm⁻² CALF-20 in the MMM layer) electrodes in 1 M KHCO₃ with flowing 10% CO₂ and N₂ balance.

FIGS. 11A and 11B. Effect of relative humidity (RH) and O₂ on the electrochemical performance. (A) Faradaic efficiencies of CO and corresponding current densities obtained at different applied potentials on the Ag/PTFE and PGDE (7 mg cm⁻² CALF-20 in the MMM layer) electrodes in 1 M KHCO₃ with flowing 15% CO₂, 4% O₂ and N₂ balance. (B) Faradaic efficiencies of CO and corresponding current densities obtained at different applied potentials on the PGDE (7 mg cm⁻² CALF-20 in the MMM layer) electrodes in 1 M KHCO₃ with flowing 15% CO₂, 4% O₂, ˜100% RH and N₂ balance.

FIGS. 12A and 12B. Schematic illustrations of exemplary permselective gas diffusion electrodes (PGDE) of this disclosure. (A) The PGDE contains a conventional gas diffusion layer which is modified by addition of a CO₂-selective MOF-MMM which renders the modified GDL selectively permeable to CO₂ (or enhances the CO₂ selectivity of the modified GDL compared to the unmodified GDL). The MOF-MMM is provided as a coating or layer on the gas-feed side of the GDL. In this configuration, a CO₂RR catalyst layer or coating is provided on the reaction side of the GDL. (B) The PGDE contains a CO₂-selective MOF-MMM, which is self-supporting or which is supported on a porous mechanical support, which is not a GDL. The MOF-MMM of FIG. 12B is generally a significantly thicker layer than the MOF-MMM coating or layer of FIG. 12A.

FIGS. 13A and 13B includes schematic illustrations of exemplary electrolyzer configurations for use with PGDE of this disclosure. (A) Illustrates a basic flow electrolyzer configuration with the cathode chamber (flow of catholyte) separated from the anode chamber (flowing anolyte) by an ion conducting membrane. (B) Illustrates a flow electrolyzer configuration with a zero-gap between the ion conducting membrane and the anode chamber with flowing anolyte.

FIG. 14 is a schematic illustration of an exemplary membrane electrode assembly for use with the PGDE of this disclosure.

### DETAILED DESCRIPTION

The present invention relates generally to production of value added C₂₊ products from reduction of CO. In embodiments, products are formed from catalytic reduction of CO and more specifically products are formed by electrocatalytic reduction of CO. In one aspect, CO and/or methane, formic acid and/or C₂₊ products are formed by electrocatalytic reduction of CO₂, wherein CO₂ is separated or captured from a CO₂-containing gas, such as flue gas. A CO₂-selective membrane before the catalyst layer in a gas diffusion electrode is used to enhance CO₂ availability for electrochemical CO₂ reduction from CO₂-containing gas streams (feed streams), and particularly from low-CO₂ concentration gas streams. CO₂ is introduced into an alkaline flow cell or membrane electrode assembly via a gas diffusion membrane, particularly a CO₂-selective gas diffusion membrane, where CO₂ is reduced employing a CO₂RR catalyst. Electrocatalytic reduction of CO₂ is believed to proceed at least in part by electrocatalytic production of CO, which in turn is electrocatalytically reduced to form other products and particularly C₂₊ products. The gas diffusion electrode also contains the CO₂ reduction reaction (CO₂RR) catalyst to facilitate reduction of CO₂ (and/or CO produced) to desired 1-carbon or multi-carbon products. In another aspect, CO is directly electrocatalytically reduced to desired C₁ and C₂₊ products. In this aspect, CO or a CO-containing gas is introduced into an alkaline flow cell or membrane electrode assembly, particularly via a gas diffusion membrane, and more particularly via a CO-selective gas diffusion membrane, where CO is reduced employing a CORR catalyst. Certain catalysts may be useful for both CO₂ and CO reduction. Of particular interest for CO reduction are CORR catalysts that facilitate formation of C₂₊ products from CO. In embodiments, the gas diffusion membrane is selective for CO adsorption. The gas diffusion electrode also contains the CO reduction reaction (CORR) catalyst to facilitate reduction of CO to desired 1-carbon or multi-carbon products.

In more detail in an aspect, the invention relates to the integration of in-situ gas separation and conversion of CO₂ or CO into value-added products. CO₂ separation, particularly from low CO₂-concentration gas streams, is facilitated by use of certain FINs exhibiting CO₂-selective adsorption incorporated into a polymer matrix forming mixed matrix membrane (MMM). In some embodiments, CO is generated by electrocatalytic reduction of CO₂ employing a CO₂-selective gas diffusion membrane employing a MMM containing a FIN exhibiting selective adsorption of CO₂. The electrocatalytically formed CO can exit the alkaline flow cell or membrane electrode assembly to proceed to reduction to desired C₁ or C₂₊ products, particularly via electro catalytic reduction employing a CORR catalyst. In another aspect, desired products are formed by electrocatalytic reduction of CO which is directly introduced into an alkaline flow cell or membrane electrode assembly which employs a CORR catalyst. CO is introduced into the cell or assembly via a gas diffusion membrane, particularly a CO-selective gas diffusion membrane. CO separation and introduction into the cell or assembly can be facilitated by use of certain FINs exhibiting CO-selective adsorption incorporated into a polymer matrix forming mixed matrix membrane (MMM). In embodiments, MMM useful for electrocatalytic reduction of CO₂ are nanoporous and preferably are selective for CO₂. In embodiments, MMM useful for electrocatalytic reduction of CO₂ are mesoporous and preferably are selective for CO₂. In embodiments, MMM useful for electrocatalytic reduction of CO are nanoporous and preferably are selective for CO. In embodiments, MMM useful for electrocatalytic reduction of CO are mesoporous and preferably are selective for CO.

MMM of this invention incorporate FINs into a selected polymer matrix to provide for a gas-selective membrane for separation of CO₂ from a CO₂-containing gas or separation of CO from a CO-containing gas.

Exemplary FINs useful in the materials devices and methods of this invention include zeolites, activated carbon, covalent organic frameworks (COF) and MOF.

MMM incorporating zeolites are useful for gas separation including separation for CO₂ or separation of CO. Zeolite-based MMM useful for separation of CO₂ are known in the art. For example, zeolite FIN materials include SAPo-34, ZSM-2, zeolite 3A, zeolite 4A, zeolite 5a and zeolite-13X, among others. [M. Maghami and A. Abdelrasoul (2017) “Zeolite mixed matrix membrane for sustainable engineering,” doi: 10.5772/intechopen.73824;

### N. S. Hassan, A. A. Jalil, M. B. Bahari, N. F. Khusnun, E. M.

Sharaf Aldeen, R. S. Mim, M. L. Firmansyah, S. Rajendran, R. R. Mukti, R. Andika, H. Devianto (2023) “A comprehensive review on zeolite-based mixed matrix membranes for CO₂/CH₄ separation,” doi.org/10.1016/j.chemosphere.2022.137709; These references are incorporated by reference herein in their entirety to the extent not inconsistent with the description herein. The references provide description of the preparation and use of MMM containing zeolites]

MMM incorporating activated carbon are useful for gas separation including separation for CO₂ or separation of CO. The sources of activated carbon for use in MMM include among others biomass, crops, such as coconut shells, wood, peat and non-crop sources including microalgae. [Lewis, Jeremy, “Enhancing Liquid And Gas Separation With Activated Carbon Mixed-Matrix Membranes” (2019). Theses and Dissertations. 2468, available at the web site commons.und.edu/theses/2468; J. Lewis et al. (2019) “Activated carbon in Mixed-matrix membranes,” Separation & Purification Reviews, 50, 2021 (issue 1) pages 1-31; Weigelt, F., Georgopanos, P., Shishatskiy, S., Filiz, V., Brinkmann, T., and Abetz, V. (2018) Development and Characterization of Defect-Free Matrimid Mixed-Matrix Membranes Containing Activated Carbon Particles for Gas Separation. Polymers, 10:1-21. These references are incorporated by reference herein in their entirety to the extent not inconsistent with the description herein. These references provide description of the preparation and use of MMM containing activated carbon.]

MMM incorporating covalent organic frameworks (COFs) are useful for gas separation including separation for CO₂ or separation of CO. COFs are similar to MOFs, but synthesised via reversible strong covalent bonds between light elements such as boron, carbon, nitrogen, and oxygen. Pure organic components of COFs give them lower density and better compatibility with other organic materials. But both crystalline porous materials are characterised by permanent porosities with very high surface areas, high thermal stabilities, and exceptional chemical stabilities in organic and aqueous media, acids, and bases. Functionality and utility of these structures are often enhanced over those obtained from polymeric materials; due to their much better-defined pore structures with narrower size distribution, increased pore stability, and the tuneable pore sizes depending on the dimensions of the building blocks used. These properties make them excellent candidates for gas separation via MMM. Compared with inorganic fillers, COFs feature the advantages of pure organic nature, high thermal and chemical stabilities, and ordered and tunable porous network structures, which are amenable to enhance the interfacial affinity and compatibility in MMMs. COFs are assembled by the atomically precise linkage of organic building blocks into highly ordered and periodic network structures. The weak interlamellar interaction between COF layers allows them to be exfoliated into 2D or even 1D nanosheets with high aspect ratios that enable the highly selective and ultrafast molecular sieving. Exemplary COFs use as fillers for MMM include Schiff base network type materials (SNW-1, SNW-2, SNW-4 etc.). Examples of useful 2D linked COF and 3D linked COF are COF-LZU1 and COF-DL229, respectively. [L. Deng, J. Zhang and Y. Gao (2018) “Synthesis, properties, and their potential application of covalent organic fameworks (COFs)”, from Mesoporous Materials-Properties and Applications (ed. M. Krishnappa), doi: 10.5772/intechopen.79068 (book), doi: 10.5772/intechopen.82322 (article); M. Fang, C. Montoro, M. Semsarilar (2020) “Metal and Covalent Organic Frameworks for Membrane Applications,” (2020). Membranes 2020, 10 (5), 107, doi.org/10.3390/membranes10050107; M. Fang, C. Montoro, M. Semsarilar (2020) “Metal and Covalent Organic Frameworks for Membrane Applications”, Membranes 2020, 10 (5), 107,doi.org/10.3390/membranes10050107. These references are incorporated by reference herein in their entirety to the extent not inconsistent with the description herein. These references provide description of the preparation and use of MMM containing activated carbon.]

FINs can be integrated with suitable polymers to form MMM. Useful polymers include among others polydimethylsiloxane (PDMS), polyoctomethylsiloxane (POMS), polyimide (PI), polyethersulfone (PES), polysulfones (PSF), sulfonated fluoropolymers, as well as block copolymers (PI-PDMS) or copolymers to form mixed matrix membranes. In embodiments, the polymer is a polysulfonated copolymer (such as those polymers designated as Nafion® (The Chemours Company FC, LLC)). In embodiments, the polymer is a polyimide that is a maleimide thermoset and thermoplastic polyimide resin (such as those polyimides designated Matrimid® (Hunstman)).

Enhanced uptake of CO₂ into the PGDE employing the FIN-MMM wherein the FIN exhibits selective adsorption of CO₂ increases the availability of CO₂ for reduction at the CO₂RR catalyst at the electrode of the PGDE.

Enhanced uptake of CO into the PGDE employing the FIN-MMM wherein the FIN exhibits selective adsorption of CO increases the availability of C₂ for reduction at the CORR catalyst at the electrode of the PGDE.

In embodiments, FINs that exhibit selective adsorption of CO₂ are incorporated with polysulfonated copolymer (such as those polymers designated as Nafion®) to form FIN-MMM which are used as gas diffusion layers or are integrated with conventional gas diffusion layers, such as polytetrafluoroethylene (PTFE) or carbon gas diffusion layers (GDL) (e.g., carbon cloth or carbon paper) to provide modified gas diffusion layers with enhanced permeability to CO₂. Such modified gas diffusion layers are used to make permselective gas diffusion electrodes (PGDE) which exhibit enhanced permeability to CO₂.

In embodiments, FINs that exhibit selective adsorption of CO are incorporated with polysulfonated copolymer (such as those polymers designated as Nafion®) to form FIN-MMM which are used as gas diffusion layers or are integrated with conventional gas diffusion layers, such as polytetrafluoroethylene (PTFE) or carbon gas diffusion layers (GDL) (e.g., carbon cloth or carbon paper) to provide modified gas diffusion layers with enhanced permeability to CO. Such modified gas diffusion layers are used to make permselective gas diffusion electrodes (PGDE) which exhibit enhanced permeability to CO.

In specific embodiments, MOFs exhibiting selective adsorption of CO₂ are incorporated with polysulfonated copolymer (such as those polymers designated as Nafion®) to form MOF-MMM which are used as gas diffusion layers or are integrated with conventional gas diffusion layers, such as polytetrafluoroethylene (PTFE) or carbon gas diffusion layers (GDL) (e.g., carbon cloth or carbon paper) to provide modified gas diffusion layers with enhanced permeability to CO₂. Such modified gas diffusion layers are used to make permselective gas diffusion electrodes (PGDE) which exhibit enhanced permeability to CO₂.

In specific embodiments, MOFs exhibiting selective adsorption of CO are incorporated with polysulfonated copolymer (such as those polymers designated as Nafion®) to form MOF-MMM which are used as gas diffusion layers or are integrated with conventional gas diffusion layers, such as polytetrafluoroethylene (PTFE) or carbon gas diffusion layers (GDL) (e.g., carbon cloth or carbon paper) to provide modified gas diffusion layers with enhanced permeability to CO. Such modified gas diffusion layers are used to make permselective gas diffusion electrodes (PGDE) which exhibit enhanced permeability to CO. MOFs exhibiting adsorption of CO are discussed in A. Evans et al. (2018) “Use of metal-organic frameworks for CO purification,” J. Material Chem A 10570-10594. MOFs having coordinately unsaturated iron (II) sites are reported to exhibit selective adsorption of CO. [D. A. Reed et a. (2017) “A spin transition mechanism for cooperative adsorption in metal-organic frameworks,” Nature 550, pages 96-100, doi: 10.1038/nature23674. A Cu-containing MOF [Cu(5-azidoisophthalate)(H₂O)] is reported for CO/N₂ separation. H. Sato et al. (2014) ‘Self-accelerating CO sorption in a soft nanoporous crystal,” Science 343:167-170. Each of the forgoing references are incorporated by reference herein in its entirety to the extent not inconsistent with the description herein, particularly for description of MOF that adsorb CO.

In embodiments, the FIN-MMM gas diffusion layer or the FIN-MMM-modified gas diffusion layer exhibits selectivity for permeation of CO₂ relative to permeation of N₂ of 2-fold or more. In embodiments, the FIN-MMM gas diffusion layer or the FIN-MMM-modified gas diffusion layer exhibits selectivity for permeation of CO₂ relative to permeation of N₂ of 4-fold or more. In embodiments, the FIN-MMM gas diffusion layer or the FIN-MMM-modified gas diffusion layer exhibits selectivity for permeation of CO₂ relative to permeation of N₂ of 5-fold or more. In embodiments, the FIN-MMM gas diffusion layer or the FIN-MMM-modified gas diffusion layer exhibits selectivity for permeation of CO₂ relative to permeation of N₂ of 10-fold or more. In embodiments, the FIN-MMM gas diffusion layer or the FIN-MMM-modified gas diffusion layer exhibits selectivity for permeation of CO₂ relative to permeation of N₂ of 20-fold or more. In embodiments, the FIN-MMM gas diffusion layer or the FIN-MMM-modified gas diffusion layer exhibits selectivity for permeation of CO₂ relative to permeation of O₂ of 2-fold or more. In embodiments, the FIN-MMM gas diffusion layer or the FIN-MMM-modified gas diffusion layer exhibits selectivity for permeation of CO₂ relative to permeation of O₂ of 4-fold or more. In embodiments, the FIN-MMM gas diffusion layer or the FIN-MMM-modified gas diffusion layer exhibits selectivity for permeation of CO₂ relative to permeation of O₂ of 5-fold or more. In embodiments, the FIN-MMM gas diffusion layer or the FIN-MMM-modified gas diffusion layer exhibits selectivity for permeation of CO₂ relative to permeation of O₂ of 10-fold or more. In embodiments, the FIN-MMM gas diffusion layer or the FIN-MMM-modified gas diffusion layer exhibits selectivity for permeation of CO₂ relative to both permeation of O₂ and N₂ of 2-fold, 4-fold, or 10-fold or more. In embodiments, the FIN-MMM gas diffusion layer or the FIN-MMM-modified gas diffusion layer exhibits selectivity for permeation of CO₂ relative to methane, ethane and/or ethylene.

Mixed matrix membranes (MMM) are hybrid or composite materials in which an inorganic filler or structured organic filler is incorporated into a polymer matrix. MMM are often employed for gas separation. MMM exhibiting selective adsorption of CO₂ are known in the art. (Hu, L. et al. (2022) J. Membrane Science 644:120140.) The inorganic filler of an MMM for use herein can be a material containing metal that exhibits enhanced adsorption of CO₂ (CO₂-adsorption selective filler). In this case, the MMM containing the CO₂-adsorption selective inorganic filler will exhibit enhanced adsorption of CO₂ compared to N₂, to O₂ or both. The loading of the CO₂-adsorption selective inorganic filler in the MMM polymer is adjusted to obtain a desired selectivity of adsorption of CO₂ compared to N₂, O₂ or both. Such CO₂-adsorption selective MMM also exhibit selective permeance to CO₂ compared to N₂, O₂ or both. A number of CO₂-adsorption selective inorganic fillers are known in the art and include, among others, metal organic frameworks (MOF) and metal-organic polyhedral (MOP), for example, MOP-3, which are nanosized discrete molecular cages. (Liu, J. et al. (2020) J. Membrane Sci. 606:118122; Fulong, C. R. P. et al. (2018) Dalton Trans. 47:7905-7915.) Structured organic fillers of an MMM for use herein can be a fully organic (no metal) and exhibit enhanced adsorption of CO₂ (compared to adsorption of N₂, O₂ or both). A number of CO₂-adsorption selective organic fillers are known in the art and include, among others, porous organic frameworks (POF), such as crystalline covalent organic frameworks (COFs) (Cheng, Y et al. (2019) J. Mater. Chem. A, 7:4549-4560), covalent triazine frameworks (CTFs), amorphous covalent organic polymers (COPs), porous aromatic frameworks (PAFs), microporous polymers (Yuan, Y. et al. (2021) J. Membr. Sci. 620:118923; Nadeali, A, et al. (2020) ACS Sustain. Chem. Eng. 8 (2020) 12775-12787); and porous liquids (Wang, D. (2021) Chem. Eng. J. 416; Wu, X. et al. (2017) J. Membr. Sci. 528:273-283.) Exemplary POF include among others COF-300 (Uribe-Romo, F. J. et al. (2009) J. Am. Chem. Soc. 131:4570-4571.)

MMM useful in this disclosure which exhibit CO₂-selective adsorption can be prepared by any known method. Inorganic or organic filler exhibiting CO₂-selective adsorption can be incorporated into a selected MMM polymer at a selected loading employing any known method. For example, a selected filler can be uniformly suspended or dissolved in an appropriate solvent in combination with polymer or polymer precursor and thereafter solvent can be removed to form the MMM. Useful filler loading levels depend upon a given filler and polymer, but generally range from 1 wt % to 85 wt %, more specifically range from 5 wt % to 60 wt %, and yet more specifically range from 30 wt % to 60 wt %.

In embodiments, the FIN-MMM gas diffusion layer or the FIN-MMM-modified gas diffusion layer exhibits selectivity for permeation of CO relative to permeation of N₂ of 2-fold or more. In embodiments, the FIN-MMM gas diffusion layer or the FIN-MMM-modified gas diffusion layer exhibits selectivity for permeation of CO relative to permeation of N₂ of 4-fold or more. In embodiments, the FIN-MMM gas diffusion layer or the FIN-MMM-modified gas diffusion layer exhibits selectivity for permeation of CO relative to permeation of N₂ of 5-fold or more. In embodiments, the FIN-MMM gas diffusion layer or the FIN-MMM-modified gas diffusion layer exhibits selectivity for permeation of CO relative to permeation of N₂ of 10-fold or more. In embodiments, the FIN-MMM gas diffusion layer or the FIN-MMM-modified gas diffusion layer exhibits selectivity for permeation of CO relative to permeation of N₂ of 20-fold or more. In embodiments, the FIN-MMM gas diffusion layer or the FIN-MMM-modified gas diffusion layer exhibits selectivity for permeation of CO relative to permeation of O₂ of 2-fold or more. In embodiments, the FIN-MMM gas diffusion layer or the FIN-MMM-modified gas diffusion layer exhibits selectivity for permeation of CO relative to permeation of O₂ of 4-fold or more. In embodiments, the FIN-MMM gas diffusion layer or the FIN-MMM-modified gas diffusion layer exhibits selectivity for permeation of CO relative to permeation of O₂ of 5-fold or more. In embodiments, the FIN-MMM gas diffusion layer or the FIN-MMM-modified gas diffusion layer exhibits selectivity for permeation of CO relative to permeation of O₂ of 10-fold or more. In embodiments, the FIN-MMM gas diffusion layer or the FIN-MMM-modified gas diffusion layer exhibits selectivity for permeation of CO relative to both permeation of O₂ and N₂ of 2-fold, 4-fold, or 10-fold or more. In embodiments, the FIN-MMM gas diffusion layer or the FIN-MMM-modified gas diffusion layer exhibits selectivity for permeation of CO relative to methane, ethane and/or ethylene. In embodiments, the FIN-MMM gas diffusion layer or the FIN-MMM-modified gas diffusion layer exhibits selectivity for permeation of CO relative to CO₂.

The inorganic filler of an MMM for use herein can be a material containing metal that exhibits enhanced adsorption of CO (CO-adsorption selective filler). In this case, the MMM containing the CO-adsorption selective inorganic filler will exhibit enhanced adsorption of CO compared to N₂, to O₂ or to both. The loading of the CO-adsoprtion selective inorganic filler in the MMM polymer is adjusted to obtain a desired selectivity of adsorption of CO compared to N₂, O₂ or both. Such CO-adsorption selective MMM also exhibit selective permeance to CO compared to N₂, O₂ or both. CO-adsorption selective inorganic fillers include, among others, metal organic frameworks (MOF), particularly those including Cu or Fe.

MMM useful in this disclosure which exhibit CO-selective adsorption can be prepared by any known method. Inorganic or organic filler exhibiting CO-selective adsorption can be incorporated into a selected MMM polymer at a selected loading employing any known method. For example, a selected filler can be uniformly suspended or dissolved in an appropriate solvent in combination with polymer or polymer precursor and thereafter solvent can be removed to form the MMM. Useful filler loading levels depend upon a given filler and polymer, but generally range from 1 wt % to 85 wt %, more specifically range from 5 wt % to 60 wt %, and yet more specifically range from 30 wt % to 60 wt %.

In specific embodiments, MOFs are incorporated with polysulfonated copolymer (such as those polymers designated as Nafion®) to form MOF-MMM which are used as gas diffusion layers or are integrated with conventional gas diffusion layers, such as polytetrafluoroethylene (PTFE) or carbon gas diffusion layers (GDL) (e.g., carbon cloth or carbon paper) to provide modified gas diffusion layers with enhanced permeability to CO₂. Such modified gas diffusion layers are used to make permselective gas diffusion electrodes (PGDE) which exhibit enhanced permeability to CO₂.

Metal organic framework (MOF) materials that exhibit enhanced selectively for adsorption of CO₂ are known in the art. MOF materials having an excellent CO₂ uptake profile with desired loading and exhibiting simultaneous adsorption and desorption owing to a concentration gradient assisted mechanism are employed for CO₂ capture. Zn-based MOF materials, in particular, display a strong ability to capture CO₂ from various gas stream sources with various gas compositions, including post-combustion flue gas with up to 4 v. % O₂ and with as low as 10 v. % CO₂.

Enhanced uptake of CO₂ into the PGDE employing the MOF-MMM increases the availability of CO₂ for reduction at the CO₂RR catalyst at the electrode of the PGDE.

In embodiments, the MOF-MMM gas diffusion layer or the MOF-MMM-modified gas diffusion layer exhibits selectivity for permeation of CO₂ relative to permeation of N₂ of 2-fold or more. In embodiments, the MOF-MMM gas diffusion layer or the MOF-MMM-modified gas diffusion layer exhibits selectivity for permeation of CO₂ relative to permeation of N₂ of 4-fold or more. In embodiments, the MOF-MMM gas diffusion layer or the MOF-MMM-modified gas diffusion layer exhibits selectivity for permeation of CO₂ relative to permeation of N₂ of 5-fold or more. In embodiments, the MOF-MMM gas diffusion layer or the MOF-MMM-modified gas diffusion layer exhibits selectivity for permeation of CO₂ relative to permeation of N₂ of 10-fold or more. In embodiments, the MOF-MMM gas diffusion layer or the MOF-MMM-modified gas diffusion layer exhibits selectivity for permeation of CO₂ relative to permeation of N₂ of 20-fold or more. In embodiments, the MOF-MMM gas diffusion layer or the MOF-MMM-modified gas diffusion layer exhibits selectivity for permeation of CO₂ relative to permeation of O₂ of 2-fold or more. In embodiments, the MOF-MMM gas diffusion layer or the MOF-MMM-modified gas diffusion layer exhibits selectivity for permeation of CO₂ relative to permeation of O₂ of 4-fold or more. In embodiments, the MOF-MMM gas diffusion layer or the MOF-MMM-modified gas diffusion layer exhibits selectivity for permeation of CO₂ relative to permeation of O₂ of 5-fold or more. In embodiments, the MOF-MMM gas diffusion layer or the MOF-MMM-modified gas diffusion layer exhibits selectivity for permeation of CO₂ relative to permeation of O₂ of 10-fold or more. In embodiments, the MOF-MMM gas diffusion layer or the MOF-MMM-modified gas diffusion layer exhibits selectivity for permeation of CO₂ relative to both permeation of O₂ and N₂ of 2-fold, 4-fold, or 10-fold or more. In embodiments, the MOF-MMM gas diffusion layer or the MOF-MMM-modified gas diffusion layer exhibits selectivity for permeation of CO₂ relative to methane, ethane and/or ethylene.

A MOF-MMM incorporates one or more MOF into a selected polymer matrix. In embodiments, MOF-MMM for use herein exhibit selective adsorption of CO₂ compared to N₂, O₂ or both. In embodiments, MOF-MMM for use herein exhibit selective adsorption of CO compared to N₂, O₂ or both. In an embodiment, a MOF-MMM exhibiting CO₂-selective adsorption is employed as the gas diffusion layer (or in place of a conventional GDL) in the PGDE to provide for selective adsorption of CO₂ to increase the availability of CO₂ in the GDL or at the interface with the CO₂RR catalyst. In an embodiment, a PGDE of this disclosure has a layer or coating of MOF-MMM integrated onto the gas-feed side of a conventional gas diffusion layer to provide for selective adsorption of CO₂ to increase the availability of CO₂ in the GDL or at the interface with the CO₂RR catalyst. In an embodiment, a MOF-MMM exhibiting CO-selective adsorption is employed as the gas diffusion layer (or in place of a conventional GDL) in the PGDE to provide for selective adsorption of CO to increase the availability of CO in the GDL or at the interface with the CORR catalyst. In an embodiment, a PGDE of this disclosure has a layer or coating of MOF-MMM integrated onto the gas-feed side of a conventional gas diffusion layer to provide for selective adsorption of CO to increase the availability of CO in the GDL or at the interface with the CORR catalyst.

Many MOF have been reported in the art to exhibit selectivity of adsorption of CO₂. In specific embodiments, MOF of the MOF-MMM of this disclosure exhibit at least 2-fold enhanced adsorption of CO₂ compared to N₂, O₂ or both. In additional embodiments, MOF of the MOF-MMM of this disclosure exhibit at least 4-fold enhanced adsorption of CO₂ compared to N₂, O₂ or both. In embodiments, MOF of the MOF-MMM of this disclosure exhibit 10-fold or higher adsorption of CO₂ compared to N₂, O₂ or both Quian, Q, et al. (2020) “MOF-based Membranes for Gas Separation,” 120:8161-8266 provides an overview of MMM containing MOF. FIG. 60 and Table 12 in this reference, for example, provide MOF useful in CO₂/N₂ separation, which are useful in the MOF-MMM of this disclosure. In specific embodiments, MOF useful in MOF-MMM of this disclosure include, among others, CALF-20, HKUST-1, MOF-5, Mg-MOF-74, various ZIF MOF, including ZIF-8, ZIF-7, ZIF-71, and ZIF-90. Additional MOF useful in MOF-MMM of this disclosure include: IRMOF-1, ZnTCPP, CAU-1, MIL-100, UiO-66-CH₃, Cu₃(BTU)₂ and NH₂-MIL-53. Additional, MOF useful in the MOF-MMM of this disclosure include UiO-66, missing-linker defect UiO-66 (Xiang, W. et al. (2020) Applied Energy 277:11556) and MUF-15 (Yin, H. et al. (2020) J. Membrane Science, 609:118245, 10 pp.). An additional MOF useful in MOF-MMM of the disclosure includes the MOF Cd₂L(H₂O)₂·5 H₂O (or Cd-6F). In embodiments herein, the MOF of the MOF-MMM is CALF-20. The listed MOF are known in the art and are commercially available or can be prepared by known methods. MOF for use in MOF-MMM of this disclosure can be assessed for selective CO₂ adsorption, for example, as described in Example 3 herein by measurement of physisorption isotherms of the pure MOF for CO₂, N₂ or other gases of interest.

MMM of this disclosure can be prepared with any appropriate polymer known in the art that is compatible with the selected inorganic or organic filler (e.g., FINs), particularly MOF, such that defect formation at the interface of the materials in the MMM is minimized. Various methods are described to select compatible MMM and fillers, particularly MOF, or to tune or improve compatibility of a given MMM polymer with a selected filler, particularly a MOF. (Quian, Q, et al. (2020) “MOF-based Membranes for Gas Separation,” 120:8161-8266, sections 5 and 6, for example). Hansen solubility parameters have been reported to be useful to assess compatibility of polymers with MOFs. (Seoane, B. et al. (2015) Chem. Soc. Rev. 44:2421-2454.) MOF can be dispersed in solutions or dispersions of selected polymers in appropriate solvents (as described in the Examples herein) and films can be layered or coated on substrates from such solutions or dispersions. Alternatively, MOF-MMM can be formed by in situ polymerization as described for example by Lin, R. et al. (2014) ACS. Appl. Mater, Interfaces, 6:5609-5618. Uniform dispersion of MOF particles in the polymer is preferred.

Particle sizes of useful FINs, particularly MOF, can range from nanometers to 10's of microns. In embodiments, nanosized filler particles, with average particle size of 1 or a few nm to 100 nm, in at least two dimensions, are used in MMM of this disclosure. In embodiments, nano-sized FIN particles (average particle size of 1 or a few nm to 100 nm in at least two dimensions) are used in FIN-MMM of this invention. In embodiments, FIN particles of average particle size of 100 nm to 500 nm in at least two dimensions are used in FIN-MMM of this disclosure. In embodiments, micron-sized FIN particles of average particle size of 0.5-100 micron in at least two dimensions are used in FIN-MMM of this disclosure.

In embodiments, nano-sized MOF particles (average particle size of 1 or a few nm to 100 nm in at least two dimensions) are used in MOF-MMM of this disclosure. In embodiments, MOF particles of average particle size of 100 nm to 500 nm in at least two dimensions are used in MOF-MMM of this disclosure. In embodiments, micron-sized MOF particles of average particle size of 0.5-100 micron in at least two dimensions are used in MOF-MMM of this disclosure.

In embodiments, a MMM exhibiting CO₂-selective adsorption is employed in a PGDE of this disclosure. In embodiments, the CO₂-selective MMM is provided as a free-standing membrane or is supported on a porous support, to enhance mechanical stability of the layer. The porous support, if used, can be electrically non-conducting. The thickness of the MMM is adjusted to provide desired CO₂-selective adsorption and to provide sufficient mechanical support for operation in the PGDE. In embodiments, the CO₂-selective MMM is provided as a layer generally ranging in thickness from about 50 to 500 microns. In embodiments, the CO₂-selective MMM is provided as a layer ranging in thickness from about 100 to 350 microns. In embodiments, the CO₂-selective MMM is provided as a coating or layer on the gas-feed side of a conventional gas diffusion layer. The thickness of the MMM is adjusted to provide desired CO₂-selective adsorption. In embodiments, where the CO₂-selective MMM is provided as a coating or layer on a gas diffusion layer, the MM layer generally ranges in thickness from 50 to 500 nm and more specifically from 100 to 350 nm. In embodiments, the MOF-containing MMM is layered, sprayed, coated or otherwise applied to the gas-feed side of a gas diffusion layer to provide a modified gas diffusion layer which exhibits enhanced selectivity of permeation of CO₂ through the modified gas diffusion layer. The modified gas diffusion layer exhibits at least enhanced permeability of CO₂ with respect to N₂ and O₂, but also may exhibit enhanced permeability of CO₂ with respect to methane, ethane or ethylene. The enhanced permeability of CO₂ is provided by incorporation of an MOF in a polymer matrix (MMM).

In embodiments, a MMM exhibiting CO-selective adsorption is employed in a PGDE of this disclosure. In embodiments, the CO-selective MMM is provided as a free-standing membrane or is supported on a porous support, to enhance mechanical stability of the layer. The porous support, if used, can be electrically non-conducting. The thickness of the MMM is adjusted to provide desired CO-selective adsorption and to provide sufficient mechanical support for operation in the PGDE. In embodiments, the CO-selective MMM is provided as a layer generally ranging in thickness from about 50 to 500 microns. In embodiments, the CO-selective MMM is provided as a layer ranging in thickness from about 100 to 350 microns. In embodiments, the CO-selective MMM is provided as a coating or layer on the gas-feed side of a conventional gas diffusion layer. The thickness of the MMM is adjusted to provide desired CO-selective adsorption. In embodiments, where the C₂-selective MMM is provided as a coating or layer on a gas diffusion layer, the MM layer generally ranges in thickness from 50 to 500 nm and more specifically from 100 to 350 nm. In embodiments, the MOF-containing MMM is layered, sprayed, coated or otherwise applied to the gas-feed side of a gas diffusion layer to provide a modified gas diffusion layer which exhibits enhanced selectivity of permeation of CO through the modified gas diffusion layer. The modified gas diffusion layer exhibits at least enhanced permeability of CO with respect to N₂ and O₂, but also may exhibit enhanced permeability of CO with respect to CO₂, methane, ethane or ethylene. The enhanced permeability of CO is provided, for example, by incorporation of an MOF exhibiting selective adsorption of CO into a polymer matrix (MMM).

As illustrated herein, loading of the MOF in the polymer matrix is important for effective adsorption of CO₂. Loading is adjusted to provide for enhanced permeability of CO₂ and can be optimized for enhanced CO₂ adsorption. In embodiments, CO₂-selective MOF loading in the polymer generally ranges from 1 wt % to 85 wt %, more specifically ranges from 5 wt % to 60 wt %, and yet more specifically ranges from 30 wt % to 60 wt %. Analogously, loading of the MOF in the polymer matrix is important for effective adsorption of CO. Loading is adjusted to provide for enhanced permeability of CO and can be optimized for enhanced CO adsorption. In embodiments, CO-selective MOF loading in the polymer generally ranges from 1 wt % to 85 wt %, more specifically ranges from 5 wt % to 60 wt %, and yet more specifically ranges from 30 wt % to 60 wt %.

In specific embodiments, the MOF loading in the MMM ranges from 3 to 11 mg cm⁻². In more specific embodiments, the MOF loading in the MMM ranges from 5 to 9 mg cm⁻². In more specific embodiments, the MOF loading in the MMM ranges from 6 to 8 mg cm².

Polymers useful in the FIN-MMM, particularly the MOF-MMM, of this invention include gas permeable polymers. Useful polymers, include copolymers and block co-polymers. These gas permeable polymers may or may not exhibit selectivity for a given gas (e.g., little or no selectivity for permeability to CO₂) or may exhibit some level of selective permeability to CO₂. The polymer of the MMM typically provides the background level of gas permeability and the MOF or other FIN is added to provide selectivity for the selected gas (e.g., CO₂ or CO). Gas-permeable polymers useful in the MMM of this disclosure include, among others, polyimides, polydimethylsiloxane, polyethylene (particularly cross-linked polyethylene XLPEO), sulfonated perfluoro resin (sold under the tradename Nafion®) and copolymers and block copolymers containing these polymers. Useful polyimides include, among others 6-FDA-durene and 6-FDA-DAM as well as the commercial polyimide sold under the tradename Matrimid® and co-polymers and block copolymers containing these polymers. Additional useful polymers for MOF-MMM include polyether block amides sold under the tradename Pebax®. Useful polymers also include polymers of intrinsic microporosity (PIM), such as PIM-1 and related polymers described in Mckeown, N. B. et al. (2006) Chem. Soc. Rev. 35:675-683 and Mckeown N. B. (2020) Polymer 122736. Polymers useful in MMM herein can display gas permeability ranging generally from 50 to 11,000 barrer. In embodiments, the gas permeability of the polymer of the MMM ranges from 100 to 5,000 barrer. In embodiments, the gas permeability of the polymer of the MMM ranges from 100 to 2,000 barrer. In embodiments, the gas permeability of the polymer of the MMM ranges from 100 to 1,000 barrer. In embodiments, the gas permeability of the polymer of the MMM ranges from 500 to 5,000 barrer.

The modified gas diffusion membranes for CO₂ reduction are also provided with a layer of CO₂RR catalyst chosen appropriately to provide a desired CO₂ reduction product. In embodiments the CO₂RR catalyst contains metal and is conductive and as such provides an electrode in the PGDE. CO₂RR catalysts include metals or metal oxides (such as, copper or silver or their oxides) or can be a MOF, including a Zn-based MOF, a ZIF (zeolite imidazolate framework) MOF and more specifically CALF-20 or ZIF-8. Exemplary CO₂RR catalysts useful in the PGDE herein include, among others, Ag, Sn, Au, Zn, PB, Ni or Cu metals or their alloys or their oxides. Useful catalysts include combinations of a metal and a metal oxide.

The modified gas diffusion membranes for CO reduction are also provided with a layer of CORR catalyst chosen appropriately to provide a desired CO reduction product. In embodiments the CORR catalyst contains metal and is conductive and as such provides an electrode in the PGDE. CORR catalysts include metals or metal oxides (such as, copper or silver or their oxides) or can be a MOF, including a Zn-based MOF, a ZIF (zeolite imidazolate framework) MOF and more specifically CALF-20 or ZIF-8. Exemplary CORR catalysts useful in the PGDE herein include, among others, Ag, Sn, Au, Zn, PB, Ni or Cu metals or their alloys or their oxides. Useful catalysts include combinations of a metal and a metal oxide. In embodiments, the same catalysts used for CO₂ reduction can be used for CO reduction.

Ag, Pb, Au are particularly selective and efficient towards CO₂ to CO formation. Such CO-selective catalysts are particularly useful in the two step process as described herein. For multi-carbon product formation, particularly for CO reduction to multicarbon products, one or more Cu catalyst is preferred. The Cu catalyst is preferably selected from polycrystalline copper, optionally doped with nanoporous carbon; a bi or tri-metallic catalyst containing copper optionally doped with other functional elements including Ag, Pb, Pd, Fe, Au, or Ru; a Cu single atom or dual atomic catalyst, optionally chemically functionalized; 3D interconnected copper (e.g., oxide derived); morphologically shaped copper catalysts (e.g., triangular, fragmented) or a hierarchical nano-range Cu catalyst.

A summary of strategies that have been used for improving Cu-based catalyst for CORR to selected products, particularly C2+ products is given in Table 2.

TABLE 2
Summary of Strategies for Improving
Cu-Based Catalysts for CORR¹⁻³

| | Main CO reduction | |
|---|---|---|
| Strategy | Products | Catalyst |
| Alloying and | n-propanol | Ag-doped CU |
| doping effects | | |
| | n-propanol | Ag—Ru co-doped Cu |
| | alcohols | Pd-doped Cu |
| | acetaldehyde | Cu—Ag |
| | acetate | Ordered CuPd |
| | CH₄ (methane) | Cu—Au |
| Single atom effects | ethylene | Cu single-atomic catalyst |
| | C₂₊ products | Cu—Cu dual-atomic catalyst |
| Crystal facet effects | acetate | Triangular-shaped Cu |
| | | nanosheet |
| | n-propanol | Fragmented Cu |
| Morphology effects | n-propanol | Cu nanocavity |
| | Liquid oxygenated | Hierarchical Cu |
| | products | |
| Oxide-derived Cu | Multi-carbon | Oxide-derived Cu |
| | oxygenates | |

¹H. J. Peng, M. T. Tang, J. Halldin Stenlid, X. Liu, F. Abild-Pedersen, Trends in oxygenate/hydrocarbon selectivity for electrochemical CO(₂) reduction to C₂ products. Nat. Commun. 13, 1-11 (2022).
²Y. Ji, A. Guan, G. Zheng, Copper-based catalysts for electrochemical carbon monoxide reduction. Cell Reports Phys. Sci. 3, 101072 (2022).
³L. Wang, S. A. Nitopi, E. Bertheussen, M. Orazov, C. G. Morales-Guio, X. Liu, D. C. Higgins, K. Chan, J. K. Nørskov, C. Hahn, T. F. Jaramillo, Electrochemical Carbon Monoxide Reduction on Polycrystalline Copper: Effects of Potential, Pressure, and pH on Selectivity toward Multicarbon and Oxygenated Products. ACS Catal. 8, 7445-7454 (2018). These references are incoproated by reference herein in their entireties to the extent not inconsistent with the description herein, particularly for descriptions of CORR catalysts useful in the present invention.

The information provided in Table 2 and the references cited therein can be used by one of ordinary skill in the art to select Cu-based catalyst for CO₂ and CO reduction, particularly with respect to selection of catalyst for formation of selected reduction products.

Catalyst may be in the form of sputtered layers of metal or metal alloys, sheets, layers or other deposits of metal or alloy nanoparticles, metal or alloy foams, meshes or other deposited or layered forms in contact with the reactive side of the gas diffusion membrane.

MOF useful as CO₂RR catalysts are described in the following: Al-Attas, T. A. et al. Ligand-Engineered Metal-Organic Frameworks for Electrochemical Reduction of Carbon Dioxide to Carbon Monoxide. ACS Catal. 11, 7350-7357 (2021) and supporting information therefor; Dou, S.; Song, J.; Xi, S.; Du, Y.; Wang, J.; Huang, Z. F.; Xu, Z. J.; Wang, X. Boosting Electrochemical CO₂ Reduction on Metal-Organic Frameworks via Ligand Doping. Angew. Chem., Int. Ed. 2019, 58, 4041-4045; Kornienko, N.; Zhao, Y.; Kley, C. S.; Zhu, C.; Kim, D.; Lin, S.; Chang, C. J.; Yaghi, O. M.; Yang, P. Metal-Organic Frameworks for Electrocatalytic Reduction of Carbon Dioxide. J. Am. Chem. Soc. 2015, 137, 14129-14135; Nam, D. H.; Bushuyev, O. S.; Li, J.; De Luna, P.; Seifitokaldani, A.; Dinh, C. T.; García De Arquer, F. P.; Wang, Y.; Liang, Z.; Proppe, A. H.; Tan, C. S.; Todorovic, P.; Shekhah, O.; Gabardo, C. M.; Jo, J. W.; Choi, J.; Choi, M. J.; Baek, S. W.; Kim, J.; Sinton, D.; Kelley, S. O.; Eddaoudi, M.; Sargent, E. H. Metal-Organic Frameworks Mediate Cu Coordination for Selective CO₂ Electroreduction. J. Am. Chem. Soc. 2018, 140, 11378-11386; Hod, I.; Sampson, M. D.; Deria, P.; Kubiak, C. P.; Farha, O. K.; Hupp, J. T. Fe-Porphyrin-Based Metal-Organic Framework Films as High-Surface Concentration, Heterogeneous Catalysts for Electrochemical Reduction of CO₂. ACS Catal. 2015, 5, 6302-6309; Al-Rowaili, F. N.; Jamal, A.; Ba Shammakh, M. S.; Rana, A. A Review on Recent Advances for Electrochemical Reduction of Carbon Dioxide to Methanol Using Metal-Organic Framework (MOF) and Non-MOF Catalysts: Challenges and Future Prospects. ACS Sustainable Chem. Eng. 2018, 6, 15895-15914; Bavykina, A.; Kolobov, N.; Khan, I. S.; Bau, J. A.; Ramirez, A.; Gascon, J. Metal-Organic Frameworks in Heterogeneous Catalysis: Recent Progress, New Trends, and Future Perspectives. Chem. Rev. 2020, 120, 8468-8535; Jiang, X.; Wu, H.; Chang, S.; Si, R.; Miao, S.; Huang, W.; Li, Y.; Wang, G.; Bao, X. Boosting CO₂ Electroreduction over Layered Zeolitic Imidazolate Frameworks Decorated with Ag₂O Nanoparticles. J. Mater. Chem. A 2017, 5, 19371-19377; Kang, X.; Zhu, Q.; Sun, X.; Hu, J.; Zhang, J.; Liu, Z.; Han, B. Highly Efficient Electrochemical Reduction of CO₂ to CH₄ in an Ionic Liquid Using a Metal-Organic Framework Cathode. Chem. Sci. 2016, 7, 266-273. Each of these references is incorporated by reference herein for descriptions of MOF CO₂RR catalysts and the formation of such catalyst layers for electrochemical CO₂ reduction.

ZIFs are a subclass of MOFs having imidazolate ligands which are useful as CO₂RR catalysts. (Huang, X. C.; Lin, Y. Y.; Zhang, J. P.; Chen, X. M. Ligand Directed Strategy for Zeolite-Type Metal-Organic Frameworks: Zinc (II) Imidazolates with Unusual Zeolitic Topologies. Angew. Chem., Int. Ed. 2006, 45, 1557-1559; Jiang, X.; Li, H.; Xiao, J.; Gao, D.; Si, R.; Yang, F.; Li, Y.; Wang, G.; Bao, X. Carbon Dioxide Electroreduction over Imidazolate Ligands Coordinated with Zn (II) Center in ZIFs. Nano Energy 2018, 52, 345-350; Zhang, J. P.; Zhang, Y. B.; Lin, J. B.; Chen, X. M. Metal Azolate Frameworks: From Crystal Engineering to Functional Materials. Chem. Rev. 2012, 112, 1001-1033.)

Exemplary MOF useful as CO₂RR catalysts include among others CALF-20, ZIF-8, ZIF-7, ZIF-108, SIM-1, ZIF-8 doped with 1,10-phenanthroline, and HKUST-1. A particularly useful CO₂RR catalyst for reduction of CO₂ to CO is CALF-20 as described in Al-Attas, T. A. et al. Ligand-Engineered Metal-Organic Frameworks for Electrochemical Reduction of Carbon Dioxide to Carbon Monoxide. ACS Catal. 11, 7350-7357 (2021) and supporting information therefor. This reference is incorporated by reference herein in its entirety to the extent not inconsistent with the description herein, particularly for descriptions of MOF catalysts and methods for making them.

Exemplary MOF-MMM useful to form PGDE for CO₂ reduction are described in the following: Al-Attas, T. A. et al. Permselective MOF-based Gas Diffusion Electrode for Direct Conversion of CO₂ from Quasi Flue Gas. ACS Energy Lett. 8, 107-115 (2023). This reference is incorporated by reference herein in its entirety to the extent not inconsistent with this description. The cited reference is incorporated by reference herein at least in part to provide additional experimental details of the MOF-MMM, the PGDE and CO₂RR described therein.

PGDE of this disclosure are integrated with appropriate electrocatalytic cells for in-situ separation and conversion of CO₂. The overall CO₂ reduction process may include separating CO₂ and directing CO₂ (owing, for example, to the concentration gradient from the incoming CO₂-containing gas mixture) towards the CO₂RR catalyst and catholyte and cathode of the electrolytic cell. In embodiments, the electrochemical cell has an alkaline flow/membrane electrode assembly configuration with an anion exchange, cation exchange or bipolar membrane separating the catholyte and the anolyte compartments of the electrocatalytic cell. Applying electric potential between the anode and cathode of the cell, results in electrocatalytic reduction of CO₂ for valuable products i.e., CO, or syngas (CO/H₂) or other CO₂ reduction products, such as methanol, formic acid, acetaldehyde, ethanol, ethylene and propanol. As is known in the art, the CO₂ reduction products produced depend on the CO₂RR catalyst employed. Extended stability of materials within the electrolytic cell results from the microporous network (97% of total surface area) and coordinated metal sites for MOF.

The term “low CO₂-concentration” gas streams refer to gas streams having a concentration of CO₂ of 50% by volume or less. Methods and devices herein are preferably applied to CO₂-containing gas streams with CO₂ concentrations of 30% by volume or less and more preferably to gas streams with CO₂ concentrations of 20% by volume or less or 10% by volume of less. CO₂-containing gas streams useful in this disclosure include those wherein N₂ is the predominant component (i.e., 50% by volume or more). CO₂-containing gas streams useful in this disclosure include those containing up to 8% by volume water vapor as well as those containing up to 5% by volume O₂. CO₂-containing gas streams useful in this disclosure specifically include flue gas streams and more specifically post-combustion flue gas streams. PGDE of this disclosure are integrated with appropriate electrocatalytic cells for in-situ separation and conversion of CO. The overall CO reduction process may include separating CO and directing CO (owing, for example, to the concentration gradient from the incoming CO-containing gas mixture) towards the CORR catalyst and catholyte and cathode of the electrolytic cell. In embodiments, the electrochemical cell has an alkaline flow/membrane electrode assembly configuration with an anion exchange, cation exchange or bipolar membrane separating the catholyte and the anolyte compartments of the electrocatalytic cell. Applying electric potential between the anode and cathode of the cell, results in electrocatalytic reduction of CO for valuable products i.e., CO reduction products, such as methanol or formic acid, or more preferably C₂₊ products, such as acetaldehyde, ethanol, ethylene and propanol. As is known in the art, the CO reduction products produced depend on the CORR catalyst employed. Extended stability of materials within the electrolytic cell results from the microporous network (97% of total surface area) and coordinated metal sites for MOF.

The term “low CO-concentration” gas streams refer to gas streams having a concentration of CO of 50% by volume or less. Methods and devices herein are applied to CO-containing gas streams with CO concentrations of 40% by volume or less or to gas streams with CO concentrations of 30% by volume or less or 20% by volume or less or 10% by volume of less. CO-containing gas streams useful in this disclosure include those wherein N₂ is the predominant component (i.e., 50% by volume or more). CO-containing gas streams useful in this disclosure include those containing up to 8% by volume water vapor as well as those containing up to 5% by volume O₂. CO.containing gas streams useful in this disclosure include those containing CO₂. CO.containing gas streams useful in this disclosure include those that contain at most traces of CO₂, e.g., 0.5% by volume or less). In embodiments, CO-containing gas streams can contain N₂, O₂ and H₂O. CO-containing gas streams useful in this disclosure specifically include waste gas streams from steel processing plants or thermal power plants.

The methods and devices herein are specifically applied to flue gas streams. Table 3 provides typical compositions and kinetic diameters for the gas molecules in post-combustion flue gas.

TABLE 3
Typical compositions and kinetic diameters for
the gas molecules in post-combustion flue gas.¹

| | | |
|---|---|---|
| Compound | Composition (%) | Kinetic diameter (Å) |

| | | |
|---|---|---|
| CO₂ | 15-16% | 3.30 |
| H₂O | 5-7% | 2.65 |
| H₂ | — | 2.89 |
| O₂ | 3-4% | 3.45 |

| | | | |
|---|---|---|---|
| CO | 20 | ppm | 3.75 |

| | | |
|---|---|---|
| N₂ | 70-75% | 3.64 |

| | | |
|---|---|---|
| SOₓ | <800 | ppm |
| NOₓ | 500 | ppm |

| | |
|---|---|
| H₂S | — |

¹D'Alessandro, D. M., Smit, B. & Long, J. R. Carbon dioxide capture: Prospects for new materials. Angew. Chemie - Int. Ed. 49, 6058-6082 (2010).

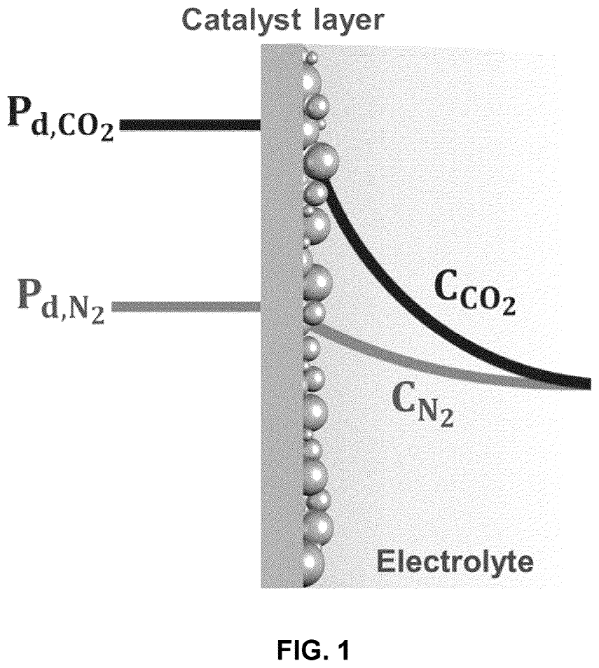

FIG. 1 schematically illustrates the concentration profile of downstream flue gas permeating through a CO₂-selective membrane then dissolving in the double-phase boundary of catalyst layer-electrolyte. P_{d,CO}_{₂} and P_{d,N}_{₂} are the downstream partial pressures of CO₂ and N₂ after permeating the CO₂-selective membrane, while C_{CO}_{₂} and CN, are the concentrations of CO₂ and N₂ in the liquid electrolyte. Passage through the CO₂-selective membrane is not expected to increase the concentration of CO₂ in the permeate, but the competitive dissolving of gases favors CO₂ leading to higher CO₂ reactant availability for CO₂R.

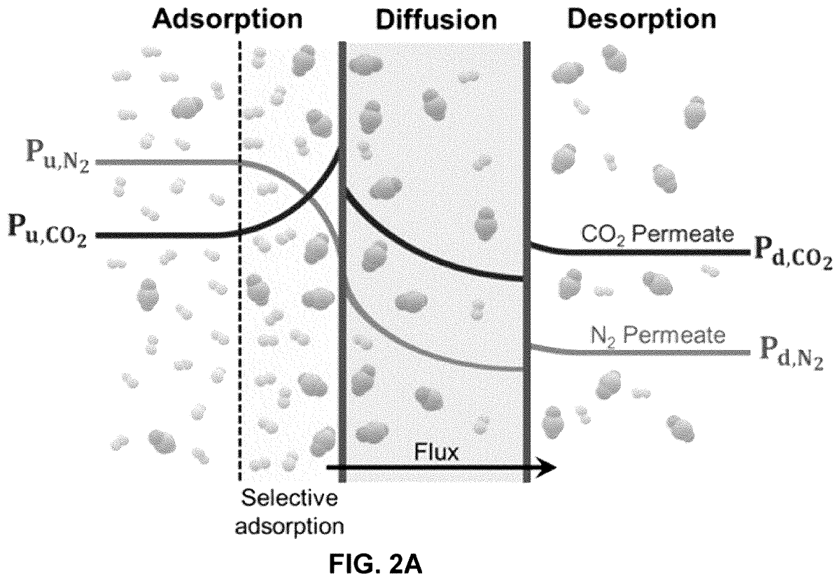

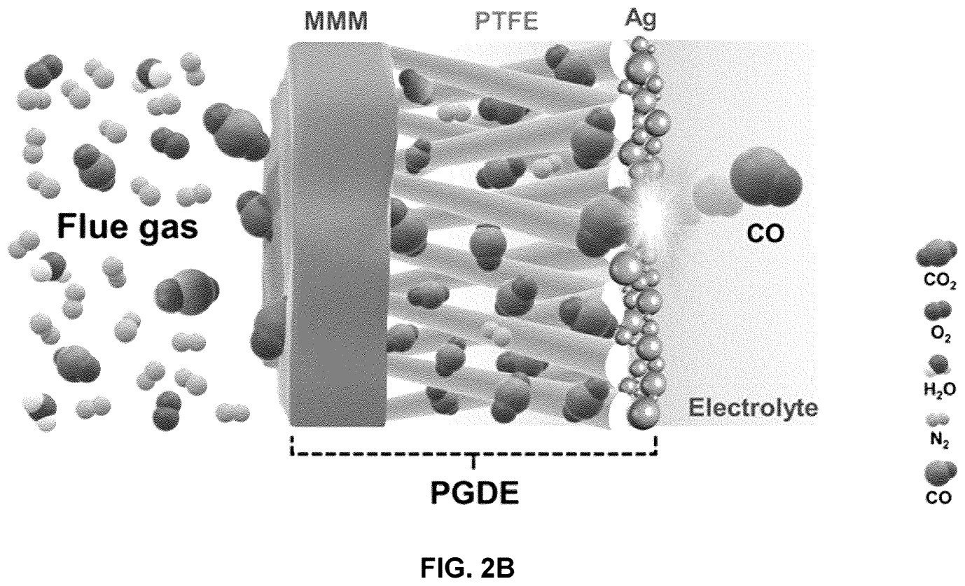

FIG. 2A is a schematic illustration (not to scale) of the adsorption-diffusion mechanism in gas membrane separation. P_{u,CO}_{₂} and P_{u,N}_{₂} and P_{u,O}_{₂} are the upstream partial pressures of CO₂, N₂ and O₂. P_{d,CO}_{₂}, P_{d,N}_{₂} and P_{d,O}_{₂} are the downstream partial pressures of CO₂, N₂ and O₂. The dashed line represents the beginning of the boundary layer. FIG. 2B is a schematic representation of an exemplary CO₂ permselective gas diffusion electrode (PGDE) of this disclosure. An MOF-based mixed matrix membrane (MMM) on the gas feed side of the PGDE and sputtered Ag as an exemplary CO₂ reduction catalyst on the reaction side of the PGDE are separated by an exemplary gas permeable polytetrafluoroethylene-based (PTFE) gas diffusion layer. Use of the MOF-based MMM leads to enhanced availability of CO₂ in the double-phase reaction interface of the gas-feed flow cell.

The permselective gas diffusion electrode (PGDE) herein is used to develop an integrated electrolyzer device for CO₂ separation and conversion from low concentration point sources. In the exemplified PGDE, a separation layer of a MOF-based mixed matrix membrane (MMM) serves to selectively permeate CO₂ from a diluted gas stream and subsequently, a silver-based catalyst electrochemically converts the CO₂ permeate into CO.

In general, any MOF or solid sorbent that selectively adsorbs CO₂, for example with respect to N₂, is useful in the permselective gas diffusion electrodes herein. As noted above, useful sorbents (also called FIN) include MOF, MOP, POF, activated carbon, zeolites, or COFs among others.

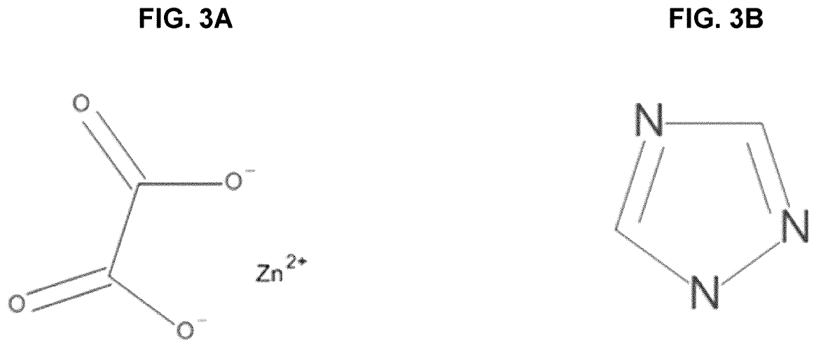

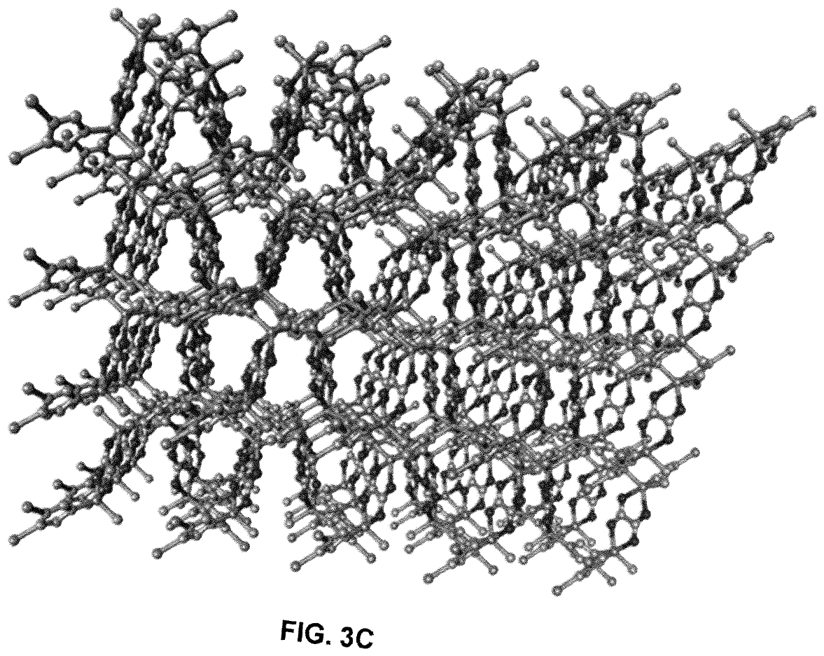

A Zn-based MOF called Calgary Frameworks 20 (CALF-20) that has been recently described (Lin, J.-B.; Nguyen, T. T. T.; Vaidhyanathan, R.; Burner, J.; Taylor, J. M.; Durekova, H.; Akhtar, F.; Mah, R. K.; Ghaffari-Nik, O.; Marx, S.; Fylstra, N.; Iremonger, S. S.; Dawson, K. W.; Partha, S.; Hovington, P.; Rajendran, A.; Woo, T. K.; Shimizua, G. K. H. A Scalable Metal-Organic Framework as a Durable Physisorbent for Carbon Dioxide Capture. Science. 2021, 1469 (December), 1464-1469; WO 2014/138878 A1, 2014; U.S. Pat. No. 9,782,745) is used herein to exemplify the permselective gas diffusion electrodes herein. The framework of this MOF includes zinc ions, oxalate, and a cycloazocarbyl (triazole) compound. FIGS. 3 (A-C) illustrate the chemical structure of A) Zinc oxalate dehydrate and B) 1,2,4-Triazole, C) 3d representation of CALF-20 framework, Zinc, oxygen, nitrogen and carbon are sky blue, red, purple, and grey, respectively. Each of the listed references is specifically incorporated by reference herein in its entirety for its description of CALF-20 MOF.

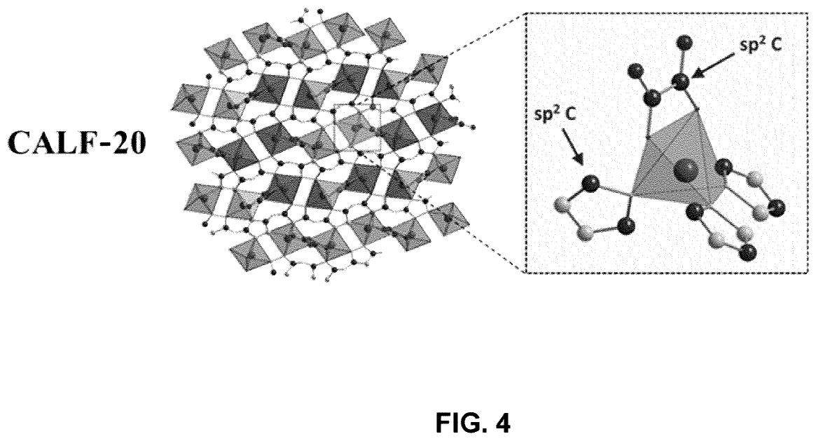

FIG. 4 is a schematic illustration of the crystal structure of CALF-20; including the chemical structure of the polyhedron zinc nodes. See: Al-Attas, T. A. et al. Ligand-Engineered Metal-Organic Frameworks for Electrochemical Reduction of Carbon Dioxide to Carbon Monoxide. ACS Catal. 11, 7350-7357 (2021).

The use of membranes for CO₂ separation from dilute sources has gained attention as an alternative to temperature, pressure, and/or vacuum swing adsorption because it has lower energy infrastructure and consumption. (Venna, S. R.; Carreon, M. A. Metal Organic Framework Membranes for Carbon Dioxide Separation. Chem. Eng. Sci. 2015, 124, 3-19.) Though, one may consider carbon capture from diluted stream with a predominant amount of N₂ through membrane separation to be energy-demanding, owing to the similarity of kinetic diameters of its main two species (dCO₂=3.3 Å, dN₂=3.64 Å). (Cseri, L.; Hardian, R.; Anan, S.; Vovusha, H.; Schwingenschlögl, U.; Budd, P. M.; Sada, K.; Kokado, K.; Szekely, G. Bridging the Interfacial Gap in Mixed-Matrix Membranes by Nature-Inspired Design: Precise Molecular Sieving with Polymer-Grafted Metal-Organic Frameworks. J. Mater. Chem. A 2021, 9 (42), 23793-23801.) Fortunately, CO₂ has a strong quadrupole moment, which leads to selective adsorption through chemical affinity separation rather than sole molecular sieving based on size exclusion. (Venna, S. R.; Carreon, M. A. Metal Organic Framework Membranes for Carbon Dioxide Separation. Chem. Eng. Sci. 2015, 124, 3-19; Butler, E. L.; Petit, C.; Livingston, A. G. Poly(Piperazine Trimesamide) Thin Film Nanocomposite Membrane Formation Based on MIL-101: Filler Aggregation and Interfacial Polymerization Dynamics. J. Memb. Sci. 2020, 596 (April 2019), 117482; Blainey, P. C.; Reid, P. J. FTIR Studies of Intermolecular Hydrogen Bonding in Halogenated Ethanols. Spectrochim. Acta-Part A Mol. Biomol. Spectrosc. 2001, 57 (14), 2763-2774.)

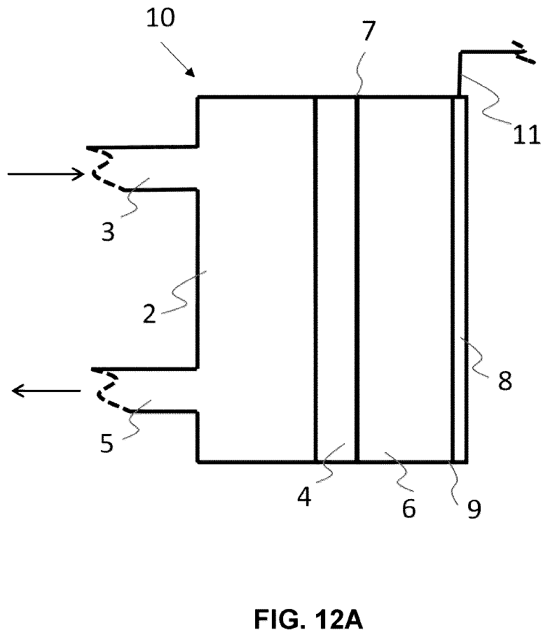

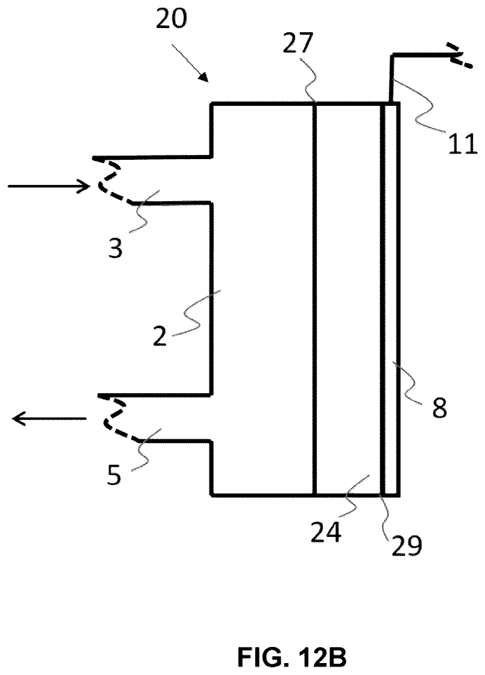

FIGS. 12A and 12B illustrate alternative configurations of a permselective gas diffusion electrode (PGDE) of this disclosure.

FIG. 12A is a schematic illustration of a permselective gas diffusion electrode (PGDE) of this disclosure (10) for application to electrochemical reduction of CO₂. The device is not drawn to scale. The electrode contains a gas chamber (2) for introduction of a CO₂-containing gas and for retrieval of gaseous products of reduction of CO₂. A gas-inlet (3) and a gas outlet (5) are illustrated for the gas chamber (2). A plurality of such gas inlets and exits may be provided as appropriate. The gas inlets and exits are provided with appropriate valves and conduits to provide and control a flow of gas to the gas chamber (2) at a desired gas pressure. It will be appreciated that other means can be employed for introducing feed gas and extracting gaseous products from the gas chamber (2).

A gas-permeable gas diffusion layer (6) has a gas-flow surface (7) and a reaction side surface (9). A metal organic framework (MOF)-containing mixed matrix membrane (MMM) layer or coating (4) is provided at the gas-flow surface (7) of the gas diffusion layer in direct contact with the GDL surface and in fluid communication with the GDL. A metal or metal-containing CO₂ reduction catalyst (CO₂RR) layer (8) is provided at the reaction side surface (9) of the gas diffusion layer (6) in direct contact with the GDL surface and in fluid communication with the GDL. CO₂ is selectively adsorbed into the MOF-MMM layer and passes into the GDL to the reaction side surface of the GDL and the catalyst layer. In this configuration, the gas diffusion layer is made of a gas permeable material other than the MOF-MMM.

FIG. 12B is an alternative exemplary PGDE configuration (20) in which the CO₂RR catalyst layer (8) forming the working electrode is positioned adjacent to and in direct contact with the MOF-containing MMM (4). In this configuration, the MOF-MMM (24) has a gas-flow surface (27) and a reaction-side surface (29). A metal or metal-containing CO₂ reduction catalyst layer (8) is provided at the reaction-side surface (29) of the MOF-MMM. The CO₂ reduction catalyst layer is directly in contact with the reaction side of the MOF-MMM. CO₂ is selectively adsorbed into the MOF-MMM layer and passes to the reaction side surface and the catalyst layer.

An electrical conductor (11) is provided in either configuration in electrical contact with the metal-containing CO₂RR catalyst layer (8) which functions as the working electrode in the PGDE. In operation of either configuration in an electrolyzer, the MOF-MMM layer that exhibits enhanced permeability for CO₂ is in fluid communication with the CO₂-containing feed gas (e.g., flue gas) and the CO₂RR catalyst/electrode layer (8) is in fluid communication with electrolyte (e.g., catholyte) of the electrolyzer.

Pressure of the CO₂-containing gas in the gas chamber (2) in either configuration can range generally from ambient atmospheric pressure up to 20 bar. Pressure of the CO₂-containing gas in the gas chamber (2) can be controlled from 1 bar to 20 bar (100 kPa-2000 kPa). In specific embodiments, pressure of the CO₂-containing gas in the gas chamber (2) can be controlled from 1 bar to 10 bar (100 kPa-1000 kPa) or 1 bar to 5 bar (100 kPa-500 kPa).

In embodiments, either configuration illustrated is adapted by selection of CO₂RR catalyst to at least predominantly generate CO. Electrocatalytically generated CO can in embodiments exit the reactor and be employed for any application. In embodiments, the electrocatalytically generated CO can be reduced by any known methods to produce value added products, such as C₂₊ products. In embodiments, the electrocatalytically generated CO can itself be electrocatalytically reduced, preferably to desirable C₂₊ products.

The PGDE herein is typically operated at ambient temperatures. More broadly, the PGDE herein can be operated at temperatures ranging from 5-80° C. In embodiments, the PGDE herein is operated at temperatures ranging from 20-70° C. In embodiments, the PGDE herein is operated at temperatures ranging from 20-50° C.

The PGDE configurations illustrated in FIGS. 12A and 12B can be employed for CO-selective adsorption and CO reduction by use of FIN-MMM where the FIN is selective for adsorption of CO from a CO-containing gas. Such configurations employ a CORR catalyst in place of a CO₂RR catalyst.

In general, the PGDE herein can be employed in any known electrolyzer or membrane electrode assembly which is useful for electrochemical reduction of CO₂ of CO.

It is noted that gaseous CO₂ or CO reduction products and any gaseous oxidation products can be assessed in the gas exiting the gas chamber (2). Liquid CO₂ or CO reduction products and liquid oxidation products exit in the catholyte flow and anolyte flow, respectively.

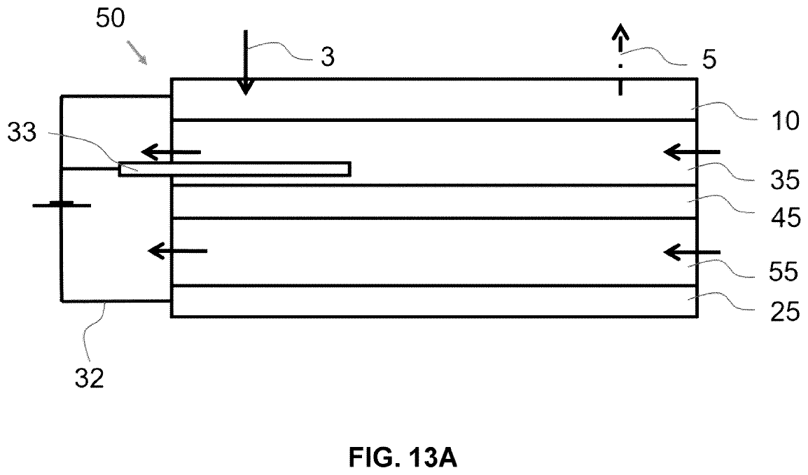

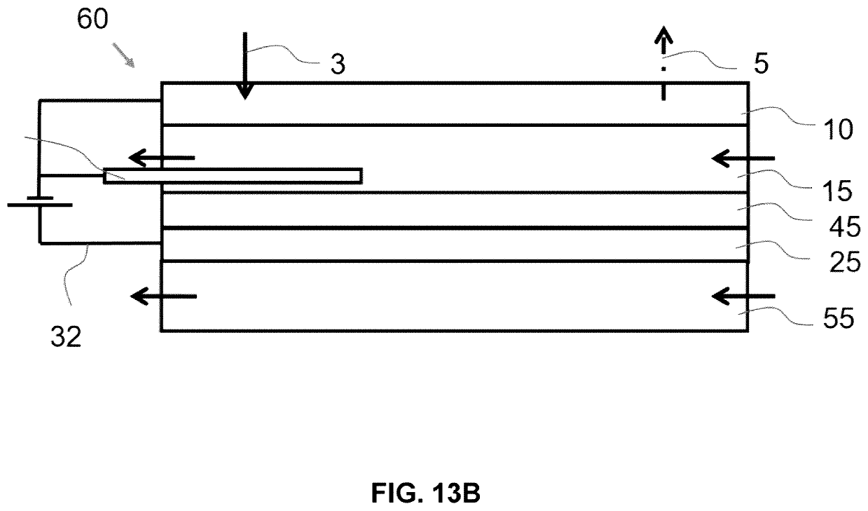

FIGS. 13A and 13B schematically illustrates exemplary configurations of flow electrolyzers of this disclosure containing a PGDE (10/20) of this disclosure. FIG. 13A illustrates a basic flow electrolyzer configuration (50) with a cathode chamber (35, with flowing catholyte) separated from an anode chamber (55, with flowing anolyte) by an ion conducting separator (45). Flow of catholyte and anolyte is illustrated by arrows. The PGDE (10/20) is adjacent the flowing catholyte and the catalyst layer of the PGDE is in fluid communication and electrical connection with the catholyte. A gas-liquid interface is formed where the catalyst layer/working electrode (8) on the PGDE contacts the catholyte. An anode (25) is provided adjacent to and in fluid communication and electrical connection with the flow of anolyte in the anolyte chamber (55). An electrical connection (32) is provided between the working electrode of the PGDE (10/20) and the anode (25). The electrolyzer is illustrated to have an optional third electrode (reference electrode 33) which allows potential of the working electrode to be monitored. Application of a selected potential across the electrodes 10/20 and 25, reduces CO₂ (and/or CO) at the catalyst/working electrode with concomitant oxidation of water/H₂ or any other oxidizable organic substance, for example, alcohols (e.g., methanol, ethanol, propanol), diols (e.g., 1,2-propanediol), olefins, triols (e.g., glycerol), polyols, sugars (e.g., glucose, fructose), sugar alcohols (e.g., sorbitol), furfurals (e.g., hydroxymethylfurfural (HMF)), among others, at the anode. One of ordinary skill in the art can select appropriate oxidizable substances appropriate for reduction of CO₂ and/or CO.

FIG. 13B illustrates an alternative configuration of electrolyzer (60) with a zero gap between the anode (25) and the ion conducting separator (45). The electrolyzer (60) is operated similarly to electrolyzer (50).

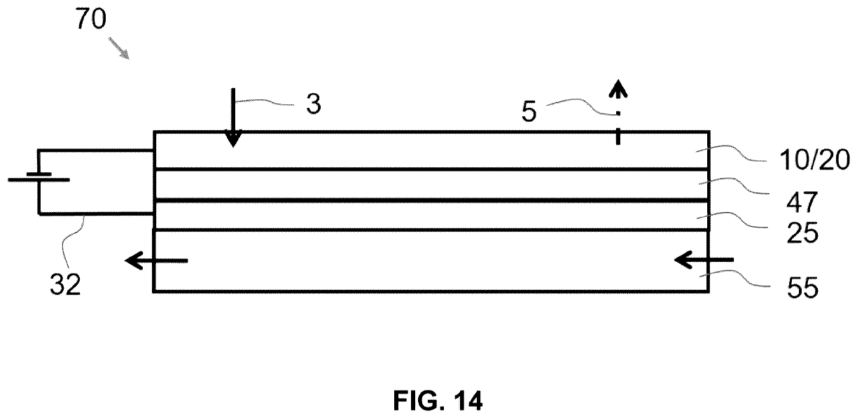

FIG. 14 is a schematic illustration of an exemplary membrane electrode assembly for use with PGDE (70) of this disclosure. In this configuration, the PGDE (10/20) containing the MOF-MMM is adjacent and in direct contact with the separator (47) which is an electrically insulating anion, cation or bipolar exchange membrane. The separator (47) separates and electrically insulates the PGDE (cathode, 10/20) and an anode (25). The anode is in fluid communication with flowing anolyte in an anolyte chamber (55).

Application of a selected potential across the electrodes 10/20 and 25, reduces CO₂ (and/or CO) at the catalyst/working electrode with concomitant oxidation of water/H₂ or other oxidizable organic substance at the anode.

The anode itself, for example, a metal, metal alloy, metal oxide or other conducting material, may function as a catalyst for the oxidation at the anode. The anode may also be provided with a catalyst to promote the oxidation reaction. The oxidation catalyst may be incorporated into the anode or be provided as a coating, deposit or layer on the anode or as a separate structure in the vicinity of the anode. Oxidation catalysts can include metals, metal oxides and metal alloys, particularly those of Ni, Ir, W, Mo, V, Fe, Ru, Au and Pt. The catalyst can be an electrochemical oxygen evolution catalyst (OER), as is known in the art, such as Ir, Ni and/or Pt. In specific embodiments, the anode catalyst is Ni, or Ni oxide or a combination thereof.

As noted, CO₂ reduction and/or CO reduction can be coupled to oxidation of oxidizable organics to generate high-value oxidation products at the anode. (Li, T. et al. (2017) ACS Cent. Sci. 3 (7): 778-783: Vass A. et al. (2022) ACS Catalysis, 12 (2): 1037-1051.) In such cases, more complex catalysts may be employed, for example, a molecular electrocatalyst such as TEMPO anchored to an appropriate anode (e.g., a metal oxide anode) can be employed for alcohol oxidation. See, for example, Bajada, M. et al. (2020) Angew. Chem. Int. Ed. Engl. 59 (36): 15633-15641.) Electrooxidation catalysts for oxidation of HMF are discussed in Yang Y. & Mu T. (2021) Green Chemistry, 23:4228-4254.

In embodiments, the gas diffusion layer is any gas diffusion layer known to be useful in fuel cell or electrolyzer applications that is compatible with application of a CO₂-selective FIN-MMM layer or a CO-selective FIN-MMM layer. In embodiments, the gas diffusion layer is a PTFE gas diffusion layer/membrane. In embodiments, the gas diffusion layer is a carbon-based gas diffusion layer/membrane, for example, carbon paper, metal-doped carbon, or carbon cloth. In embodiments, the gas diffusion layer can be a porous metal, such as a metal foam, perforated metal sheets, or sintered metal, or a porous ceramic material. In embodiments, the gas diffusion layer is microporous.

The separator employed in the electrolyzers and membrane electrode assemblies herein can be an anion exchange membrane, cation exchange membrane or a bipolar membrane. Jaroszek, H and Dydo, P (2016) “lon-exchange membranes in chemical synthesis,” Open Chemistry doi.org 10.1515/chem-2016-0002) provides an overview of anion exchange membranes and bipolar membranes. A bipolar membrane (BPM) is a layered ion exchange membrane having a negatively charged cation-exchange layer (CEL), and a positively charged anion-exchange layer (AEL) and an interface between example, these layers the “interfacial layer” (IL), or bipolar junction. BPM do not have ion transport across them. Water is electrolytically dissociated into protons and hydroxide ions at the bipolar junction. The electrolytic dissociate of water at the bipolar junction occurs without gas formation. (Parnamae, R. et al. (2021) “Bipolar membranes” A review on principles, latest development, and applications,” J. Membrane Science 617:118538). For a given electrolyzer or membrane electrode assembly, one of ordinary skill in the art can select an appropriate separator for a given CO₂ and or CO reduction and accompanying oxidation reaction that are compatible with the MMM, gas diffusion layers, and catalysts employed.

The electrolyzers and membrane electrode assemblies exemplified herein employ aqueous catholyte and anolyte solutions. Electrolytes employed are those appropriate for CO₂ and/or CO reduction and the accompanying oxidation reaction. Electrolytes are typically aqueous solutions of selected salts or mixtures of salts. Salt solutions range generally in concentration from 0.1 to 2 M in the selected salt and more specifically in concentration ranging from 0.5 to 1.5 M in the salt. In a specific embodiment the salt concentration in the electrolyte ranges from 0.8 to 1.2 M in the salt. Electrolytes can be chosen from those that are acidic (with pH lower than 6.5), neutral (those with pH ranging from 6.5 to 7.5) and those that are basic (with pH greater than 7.5). Specific electrolyte salts include bicarbonate salts and hydroxide salts. In specific embodiments, the catholyte is an aqueous solution of a bicarbonate salt, such as an alkali metal or alkaline earth metal bicarbonate salt that is water soluble at the concentration to be employed. In more specific embodiments, the catholyte is aqueous KHCO₃ or NaHCO₃. In embodiments, the anolyte is an aqueous solution of a hydroxide salt, such as an alkali metal or alkaline earth metal hydroxide that is water soluble at the concentration that is to be employed.

One of ordinary skill in the art can select appropriate catholytes and anolytes for a given CO₂ and/or CO reduction and accompanying oxidation reaction that are compatible with the MMM, gas diffusion layers, and catalysts for use in a selected electrolyzer or membrane electrode assembly used for CO₂ and/or CO reduction.

All references throughout this application, for example patent documents including issued or granted patents or equivalents; patent application publications; and non-patent literature documents or other source material; are hereby incorporated by reference herein in their entireties, as though individually incorporated by reference, to the extent that they are not inconsistent with the description herein. All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim. U.S. patent 9,82,745 and corresponding PCT application WO2014/138878, as well as PCT application WO2019/204934 are each incorporated by reference herein its entirety for descriptions of Zn-MOF, including CALF-20, which are useful in MMM of this disclosure. These references are also incorporated by reference herein to provide descriptions of properties of Zn-MOF, including CALF-20, such as surface area and particle size, as well as methods of preparation of the Zn-MOF, methods of granularization of the Zn-MOF, and methods of activating Zn-MOF for adsorption of CO₂.

When a group of substituents, species or compound, or device elements is disclosed herein, it is understood that all individual members of those groups and all subgroups, including any isomers and enantiomers of the group members, and classes of compounds that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds, if used, are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination.

One of ordinary skill in the art will appreciate that methods, starting materials, synthetic methods, and characterization methods, other than those specifically exemplified can be employed in the practice of the invention without resort to undue experimentation. All art-known functional equivalents, of any such methods, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

### THE EXAMPLES

### Example 1: Materials Preparation

### CALF-20 Synthesis

Zinc oxalate dihydrate and 1,2,4-Triazole (1:1 mole) are mixed in a Teflon liner with 100% pure ethanol. After mixing, the solution should appear milky white and opaque. The Teflon liner is then sealed in a stainless-steel autoclave and placed in an oven at 180° C. for 48 h. The solid product is collected by filtration and washed with ethanol. FIGS. 3 (A and B) shows the chemical structure of zinc oxalate dihydrate and 1,2,4-triazole. International patent applications WO2014/138878 and WO2019/204934 provide description, in particular of CALF-20 and methods for its synthesis. These references are incorporated by reference herein in their entirety to the extent not inconsistent with the description herein for descriptions of the structure, properties and methods of synthesis of Calf-20.

### Preparation of the CALF-20-Based MMM

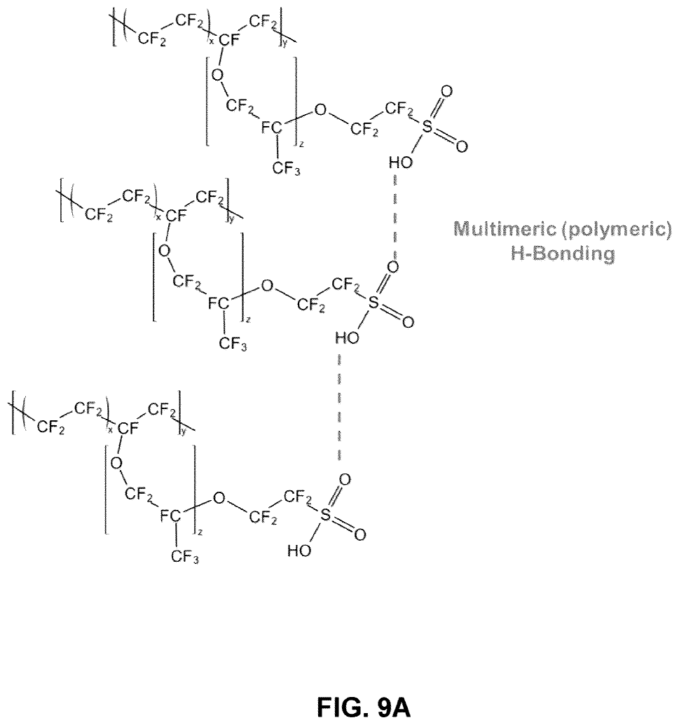

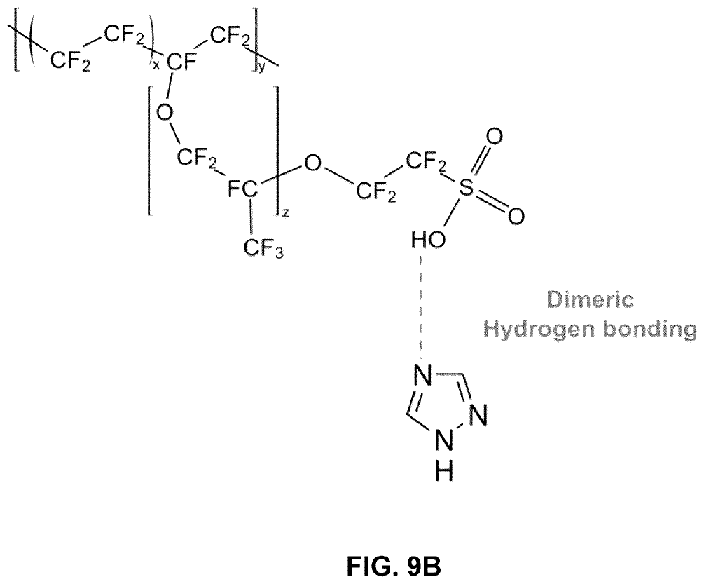

CALF-20 was dispersed in a mixture of methanol (anhydrous, 99.8%, Sigma-Aldrich) and sulfonated perfluorinated resin solution (Nafion®, Trademark of The Chemours Company FC, LLC, Wilmington DE, purchased from Sigma-Aldrich) at ratios of 1 mg CALF-20:20 μL resin solution: 0.1 mL methanol. The resin solution is 5 wt % resin in a mixture of lower aliphatic alcohols and water (contains 45% water). The sulfonated perfluorinated resin is introduced as a dispersion solution to form a homogeneous ink with the MOF and further to help attach onto the surface of the PTFE substrate (see below). The mixture is sonicated for one hour to produce the MMM ink. The generic structure of the fluoropolymer resin is illustrated in FIGS. 9A and 9B. Table 4 shows the gas permeability in dry Nafion® at 2 atm and 35 C.

TABLE 4
Gas permeability in dry Nafion ® at 2 atm and 35 C.

Permeability (barrers)

| Gas | Ref. [#] | Ref. [*] |
|---|---|---|
| N₂ | 0.24 | 0.26 |
| O₂ | 1.01 | 1.08 |
| CO₂ | 2.3 | 2.4 |

[#] Mukaddam, M., Litwiller, E. & Pinnau, I. Gas Sorption, Diffusion, and Permeation in Nafion. Macromolecules 49, 280-286 (2016).
[*] Chiou, J. S., Maeda, Y. & Paul, D. R. Gas permeation in a dry Nafion ® membrane. Ind. Eng. Chem. Res. 27, 2161-2164 (1988).

### Ag/PTFE/MMM Permselective Gas Diffusion Electrode (PGDE)

A PTFE substrate (1 cm×1 cm) (ZX Instrument Co., Ltd, 0.45 μm pore size, 100-200 μm thickness) is used as the diffusion layer. A 300 nm thick sputtering of silver is applied on a surface of the PTFE substrate (designated the front surface) using a CMS-18 reactive sputtering system (Kurt J. Lesker, Jefferson Hills, PA) at a sputtering rate of 40 nm per minute at 300 W. The flow rate of argon (Ar) carrier gas is around 139 s.c.c.m. This sputtered silver layer is the CO₂R catalyst layer and the working electrode.

The aqueous/methanol resin solution is spray-coated on the other surface of the PTFE substrate (designated the backside) by nitrogen gun spraying with a loading that was kept at 7±0.1 mg cm⁻². This spray-coated layer is the CO₂ capture layer of the gas diffusion electrode. In operation in an electrolyser, the CO₂ capture layer is in fluid communication with the CO₂-containing gas, such as a flue gas, and the metal sputtered front surface is in fluid communication with electrolyte.

### Example 2: Materials Characterization

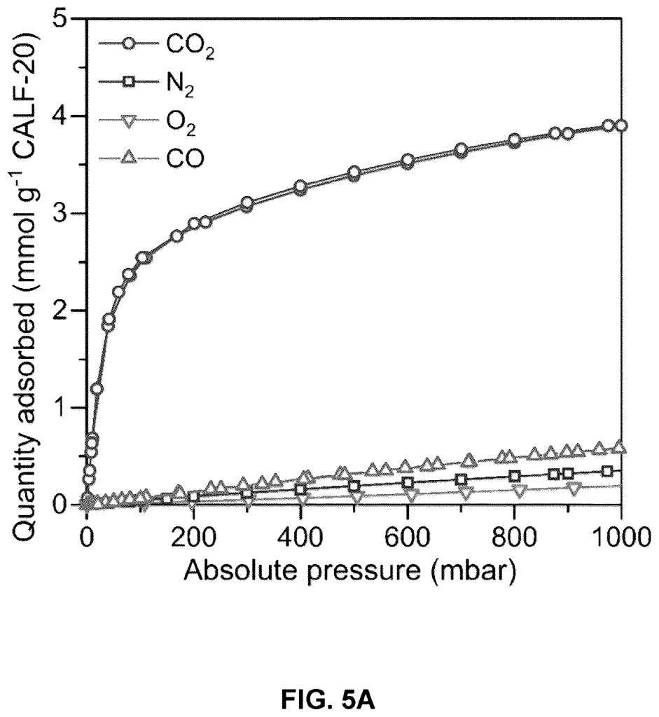

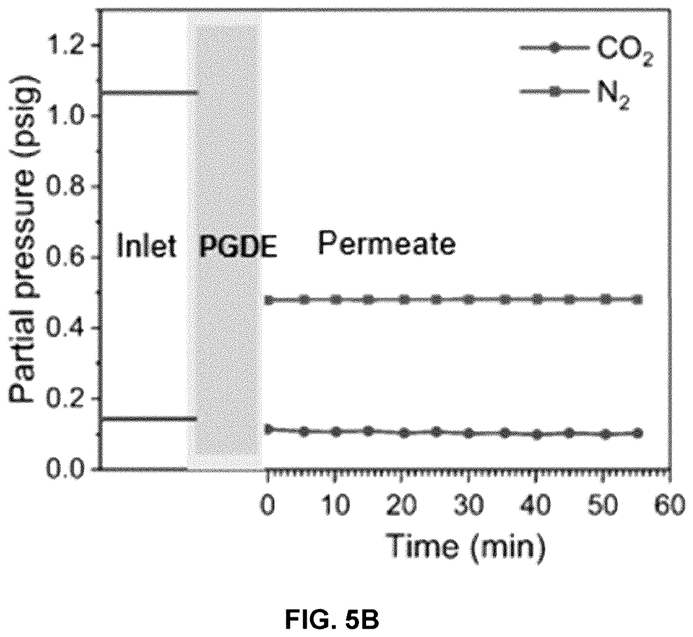

Gas adsorption experiments on pure CALF-20 are performed for CO₂, N₂, CO and O₂ (FIG. 5A). The CO₂ physisorption isotherm shows that CALF-20 exhibits more than 4.5 times higher uptake for CO₂ (3.97 mmol/g) compared to N₂, CO and O₂ at 298 K, 1 bar. The effect of higher uptake capacity of PGDE is also described in FIG. 5B which shows smaller drop in CO₂ partial pressure (inlet vs permeate) as compared to N₂. The calculated Brunauer-Emmett-Teller (BET) surface area from the CO₂ isotherm at 298 K for CALF-20 is 515.2 m²/g. Atomistic Grand Canonical Monte Carlo (GCMC) simulations of the N₂ and CO₂ isotherms indicate that the binding of CO₂ on the CALF-20 structure is entirely through physisorption, with the shortest interatomic distance between the CO₂ oxygen and a hydrogen of the triazole at 3.03 Å. (Lin, J.-B.; Nguyen, T. T. T.; Vaidhyanathan, R.; Burner, J.; Taylor, J. M.; Durekova, H.; Akhtar, F.; Mah, R. K.; Ghaffari-Nik, O.; Marx, S.; Fylstra, N.; Iremonger, S. S.; Dawson, K. W.; Partha, S.; Hovington, P.; Rajendran, A.; Woo, T. K.; Shimizua, G. K. H. A Scalable Metal-Organic Framework as a Durable Physisorbent for Carbon Dioxide Capture. Science. 2021, 1469 (December), 1464-1469.) The interactions between CO₂ and CALF-20 are dominated by the attractive dispersion forces (85%), while the rest of the binding is due to electrostatics.

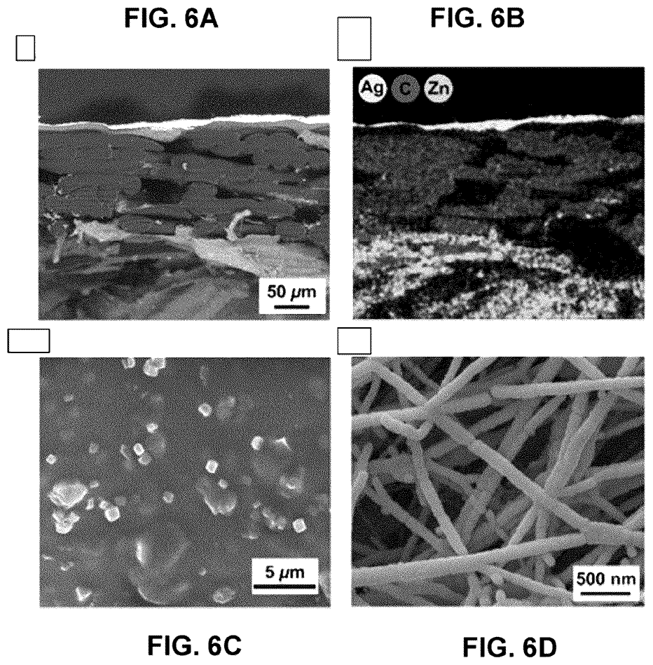

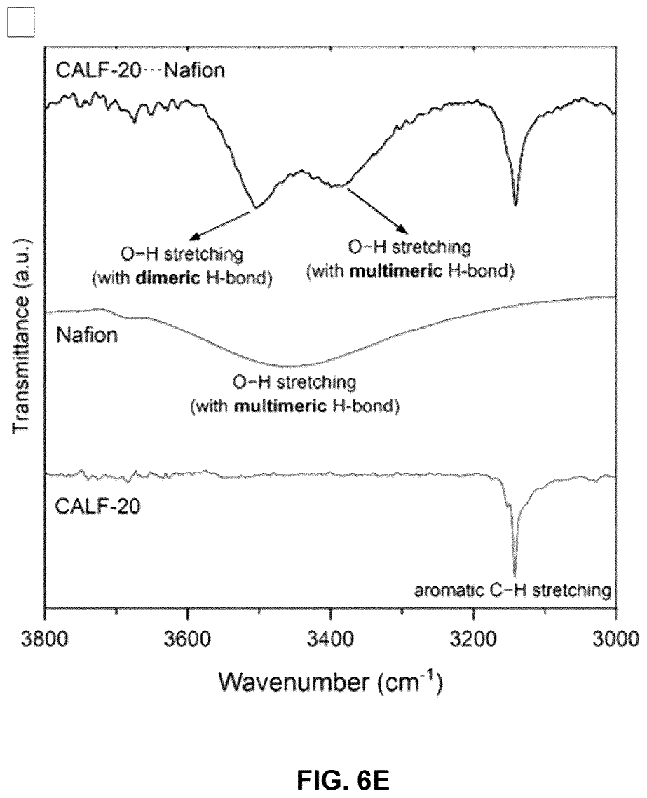

As described above, the PGDE is prepared by incorporating a MOF-based PTFE mixed matrix membrane (MMM) on the gas diffusion side (backside) of the electrode (Ag/PTFE). FIG. 6A shows a cross-section scanning electron microscopy image of the prepared Ag/PTFE/MMM PGDE electrode. The energy-dispersive X-ray spectroscopy (EDX) image reveals that the PTFE fiber of the gas diffusion layer (GDL) is sandwiched between the Ag catalyst layer (top) and the Zn-based CALF-20 capture layer (bottom) (FIG. 6B).

In MMM, the lack of good adhesion between the filler and the polymer matrix is reported to cause nanosized gaps, which compromise membrane performance. (Cseri, L.; Hardian, R.; Anan, S.; Vovusha, H.; Schwingenschlogl, U.; Budd, P. M.; Sada, K.; Kokado, K.; Szekely, G. Bridging the Interfacial Gap in Mixed-Matrix Membranes by Nature-Inspired Design: Precise Molecular Sieving with Polymer-Grafted Metal-Organic Frameworks. J. Mater. Chem. A 2021, 9 (42), 23793-23801; Butler, E. L.; Petit, C.; Livingston, A. G. Poly(Piperazine Trimesamide) Thin Film Nanocomposite Membrane Formation Based on MIL-101: Filler Aggregation and Interfacial Polymerization Dynamics. J. Memb. Sci. 2020, 596 (April 2019), 117482.) However, FIG. 6C, indicates the absence of interfacial gaps around the CALF-20 crystals in the MMM.

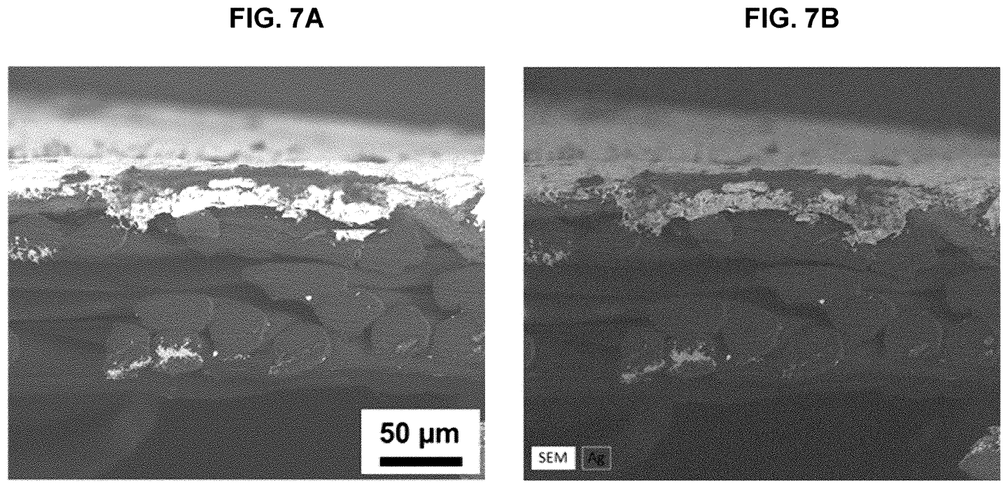

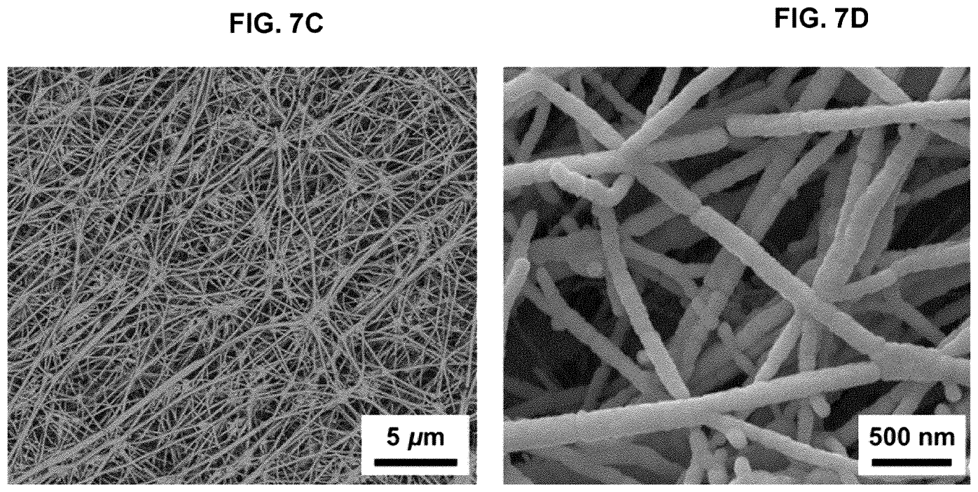

FIG. 6D provides an SEM image of Ag side of the PGDE. FIG. 7A provides a cross-section scanning electron microscopy (SEM) image and FIG. 7B the corresponding energy-dispersive X-ray spectroscopy (EDX) image of the Ag/PTFE electrode. FIGS. 7C and 7D provide scanning electron microscopy (SEM) images of the Ag side of the PGDE (C, 5 micron scale; D, 500 nm scale).

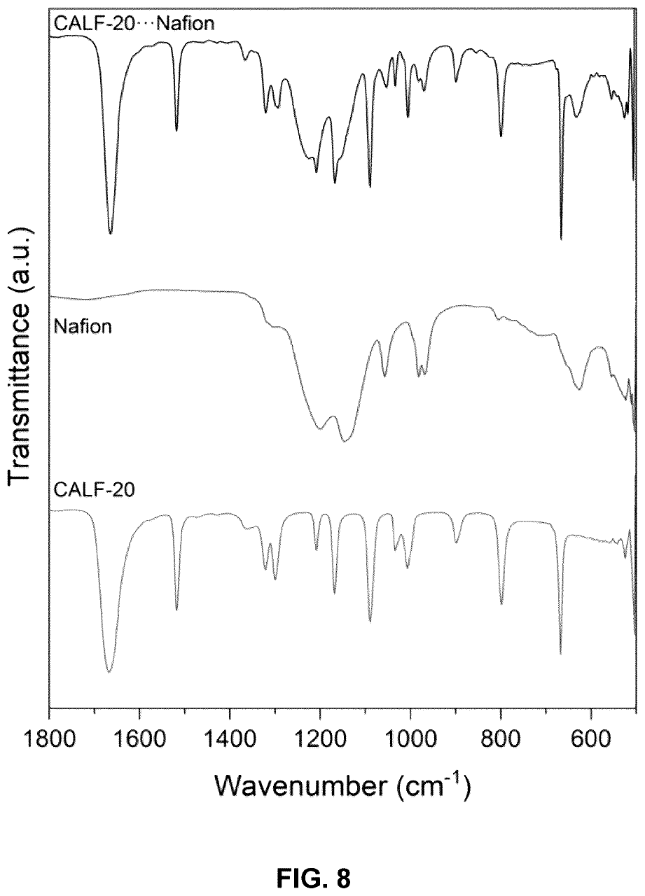

Fourier-transform infrared spectroscopy (FTIR) is performed to further understand the interfacial interactions between the MOF and the fluoropolymer resin in the MMM. The FTIR spectrum of the MMM layer shows coinciding vibrations bands relative to pure fluoropolymer resin and pure CALF-20 in the fingerprint region between 500-1700 cm⁻¹ (FIG. 8). There are two vibration bands in the OH-stretching region of the spectrum (FIG. 6E). The broad vibration band centered between 3300 and 3400 cm⁻¹ is attributed to extended intermolecular hydrogen-bonding. (Blainey, P. C.; Reid, P. J. FTIR Studies of Intermolecular Hydrogen Bonding in Halogenated Ethanols. Spectrochim. Acta-Part A Mol. Biomol. Spectrosc. 2001, 57 (14), 2763-2774.) This band matches the broad OH-stretching band of the pure fluoropolymer, which is due to its multimeric extended intermolecular hydrogen-bonding (FIG. 9A). A new band centered at ˜3500 cm⁻¹ is assigned to OH-stretching of the fluoropolymer with dimeric hydrogen-bonding, which may be attributed to the interactions between the sulfonic acid group of the fluoropolymer resin and the triazole of CALF-20 (FIG. 9B).

### Example 3: Electrochemical Performance of the PGDE

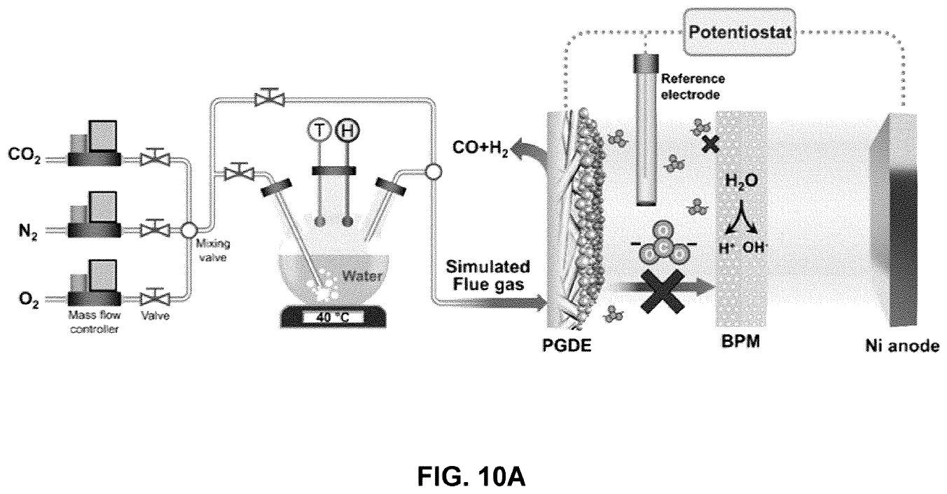

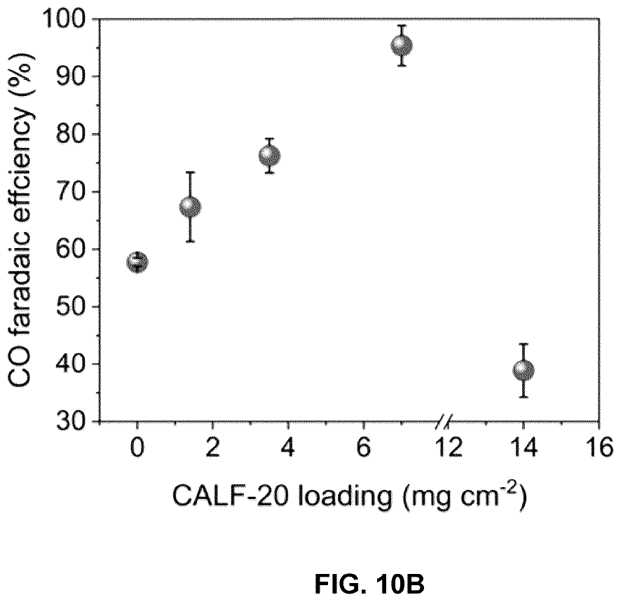

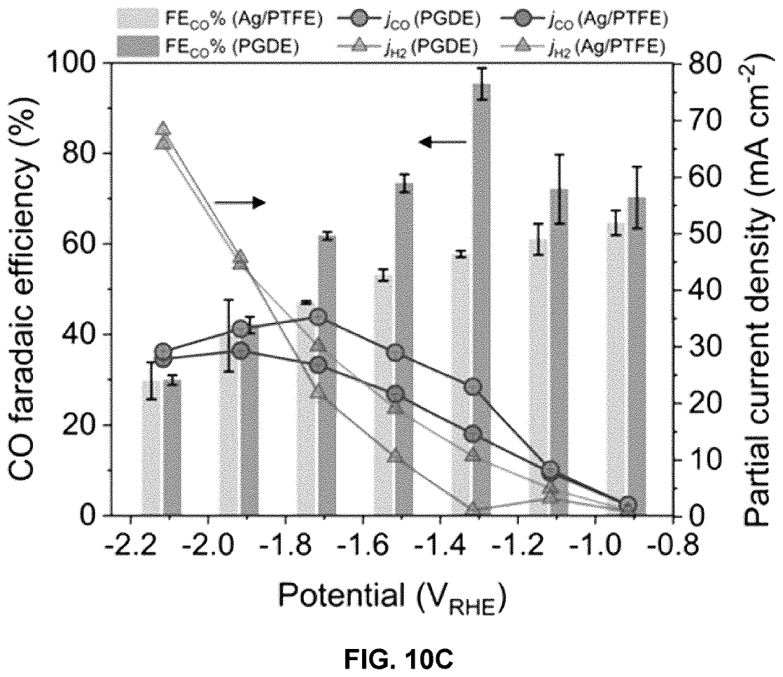

Electrochemical performance of the PGDE is tested in a liquid flow configuration electrolyzer (as shown schematically in FIG. 10A).

The electrolytic measurements of the CO₂ reduction are carried out in a three-electrode electrochemical cell with 1 cm² catalyst surface area. Addition of a reference electrode allows potential to be monitored. The cell consists of three compartments, i.e., anolyte chamber, catholyte chamber, and a gas chamber. The catholyte chamber is separated from the gas chamber by the gas diffusion working electrode. Anolyte and catholyte compartments are separated by a bipolar membrane (Fumasep FBM-PK, Fuel Cell Store). The working, reference and counter electrodes employed are the CO₂RR catalyst (e,g., sputtered Ag), Ag/AgCl electrode (3.5 M KCl saturated with silver chloride, CH Instruments, Inc.), and nickel foam (1.6 mm thickness, 350 gm⁻² surface density, MTI Corporation), respectively.

All electrochemical experiments were performed at ambient conditions (room temperature and atmospheric pressure). The flue gas stream employed has slightly higher total pressure against the PGDE than atmospheric pressure due to the flow (dynamic pressure), which enhances gas diffusion through the PGDE. The gas pressure was not monitored, however, the flow rate was kept at 100 sccm.

Catholyte (1 M KHCO₃) and anolyte (1 M KOH) were recirculated using silicon tubes connected to peristaltic pumps (Cole-Parmer) at a flow rate of 20 mL min⁻¹. For the gas supply, digital mass flow controllers (Cole-Parmer, model: 32907-63) were connected to a CO₂ cylinder (Air Liquide), N₂ cylinder (Air Liquide) and O₂ cylinder (Air Liquide) to control flow rate of each gas to feed the mixed gas to the cell. Humidity was introduced by continuously bubbling of the mixed gas through water. The flowrate of the mixed gas was kept steady at 100 s.c.c.m.

Chronoamperometry was performed at ambient pressure using a Bio-Logic potentiostat (SP-300) potentiostat/galvanostat. The applied potentials were converted from the Ag/AgCl scale to the reversible hydrogen electrode (RHE) scale for the sake of consistency using the Nernst equation:

E_{RHE}=E_{Ag/AgCl (3.5 M KCl)}+0.059×pH+0.205

The catholyte chosen for the experiments is 1 M KHCO₃ to minimize CO₂ loss in the electrolyte. A bipolar membrane (BPM) was used to further prevent CO₂ crossover to the anolyte. The BPM consists of an anion exchange layer, a cation exchange layer and an interfacial layer there between. (Wang, N.; Miao, R. K.; Lee, G.; Vomiero, A.; Sinton, D.; Ip, A. H.; Liang, H.; Sargent, E. H. Suppressing the Liquid Product Crossover in Electrochemical CO₂ Reduction. SmartMat 2021, 2 (1), 12-16.) The water dissociation (H⁺ and OH⁻ towards the cathode and anode, respectively) at the interfacial layer of the BPM suppresses carbonate anions flow towards the anode (FIG. 10A). (Wang, N.; Miao, R. K.; Lee, G.; Vomiero, A.; Sinton, D.; Ip, A. H.; Liang, H.; Sargent, E. H. Suppressing the Liquid Product Crossover in Electrochemical CO₂ Reduction. SmartMat 2021, 2 (1), 12-16; Rabinowitz, J. A.; Kanan, M. W. The Future of Low-Temperature Carbon Dioxide Electrolysis Depends on Solving One Basic Problem. Nat. Commun. 2020, 11 (1), 10-12; Ma, M.; Clark, E. L.; Therkildsen, K. T.; Dalsgaard, S.; Chorkendorff, I.; Seger, B. Insights into the Carbon Balance for CO₂ Electroreduction on Cu Using Gas Diffusion Electrode Reactor Designs. Energy Environ. Sci. 2020, 13 (3), 977-985; O'Brien, C. P.; Miao, R. K.; Liu, S.; Xu, Y.; Lee, G.; Robb, A.; Huang, J. E.; Xie, K.; Bertens, K.; Gabardo, C. M.; Edwards, J. P.; Dinh, C. T.; Sargent, E. H.; Sinton, D. Single Pass CO₂ Conversion Exceeding 85% in the Electrosynthesis of Multicarbon Products via Local CO₂ Regeneration. ACS Energy Lett. 2021, 6 (4), 2952-2959.

The diluted gas stream is flowed to the electrolyzer with 10% CO₂ and nitrogen balance. Under CO₂R conditions, the only gaseous products are CO and H₂, while NMR detected no liquid products. The gaseous products are analyzed using a gas chromatograph from the retentate stream since CO and H₂ diffuse back through the PGDE because of their low solubilities in the electrolyte (0.028 and 0.0016 g gas/kg water at 293 K, respectively). FIG. 10B shows the effect of the CALF-20 loading in the MMM layer which was investigated by varying its loading from 0 to 14 mg cm⁻². The highest CO faradaic efficiency was obtained at an optimum loading of 7 mg cm⁻². Increasing the CALF-20 loading was found to have an adverse effect on the CO faradaic efficiency, even when compared to the bare Ag/PTFE, due to blocking the pores of the gas diffusion layer.

FIG. 10C shows the CO faradaic efficiency and current density via screening the potential range between −0.92 and −2.12 V_{RHE} for the Ag/PTFE electrode with and without the MMM layer. The CO faradaic efficiency gives a maximum CO faradaic efficiency of 95% for the PGDE compared to 58% for the bare Ag/PTFE at −1.32 V_{RHE}. The difference in CO faradaic efficiency between the bare electrode and PGDE decreases while applying higher cathodic biases. This behaviour shows that the process is not limited by CO₂ availability at high applied overpotentials, but rather is limited by the competing hydrogen evolution reaction (HER).

The total current density was not affected by introducing the permselective MMM layer. The selective separation of CO₂ in the MMM layer is due to the formation of a CO₂ adsorption layer during the adsorption-diffusion mechanism, where the permeation of N₂ is hindered at certain concentrations. (Liu, Z.; Yang, H.; Kutz, R.; Masel, R. I. CO₂ Electrolysis to CO and O₂ at High Selectivity, Stability and Efficiency Using Sustainion Membranes. J. Electrochem. Soc. (2018) 165 (15), J3371-J3377.) Moreover, previous studies suggest that the diffusion selectivity through the MOF-based membrane is due to N₂ size exclusion. (Liu, Z.; Yang, H.; Kutz, R.; Masel, R. I. CO₂ Electrolysis to CO and O₂ at High Selectivity, Stability and Efficiency Using Sustainion Membranes. J. Electrochem. Soc. (2018) 165 (15), J3371-J3377; Yin, H.; Wang, J.; Xie, Z.; Yang, J.; Bai, J.; Lu, J.; Zhang, Y.; Yin, D.; Lin, J. Y. S. A Highly Permeable and Selective Amino-Functionalized MOF CAU-1 Membrane for CO₂—N₂ Separation. Chem. Commun. 2014, 50 (28), 3699-3701.

Selective adsorption in the MMM elevates the partial pressure profile of CO₂ (compared to N₂) within the adsorption boundary layer, which results in maintaining high downstream pressure even after diffusing through the membrane medium (FIG. 2A).

### Example 4: Effect of MOF Loading

The effect of CALF-20 loading in the MMM layer is investigated by varying MOF loading in the MMM from 0 to 14 mg cm⁻² (FIG. 10B). The highest CO faradaic efficiency was obtained by an optimum loading of 7 mg cm⁻². Increasing the CALF-20 loading was found to have an adverse effect on the CO faradaic efficiency, even when compared to the bare Ag/PTFE, due to blocking the pores of the gas diffusion layer of the electrode.

### Example 5: Effect of Addition of Oxygen and Water to CO₂/N₂ Feed Stream

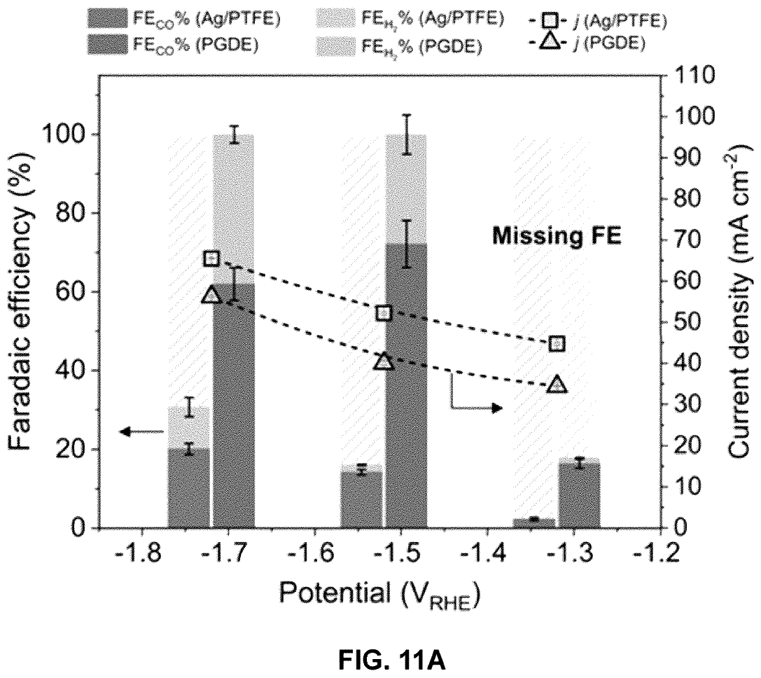

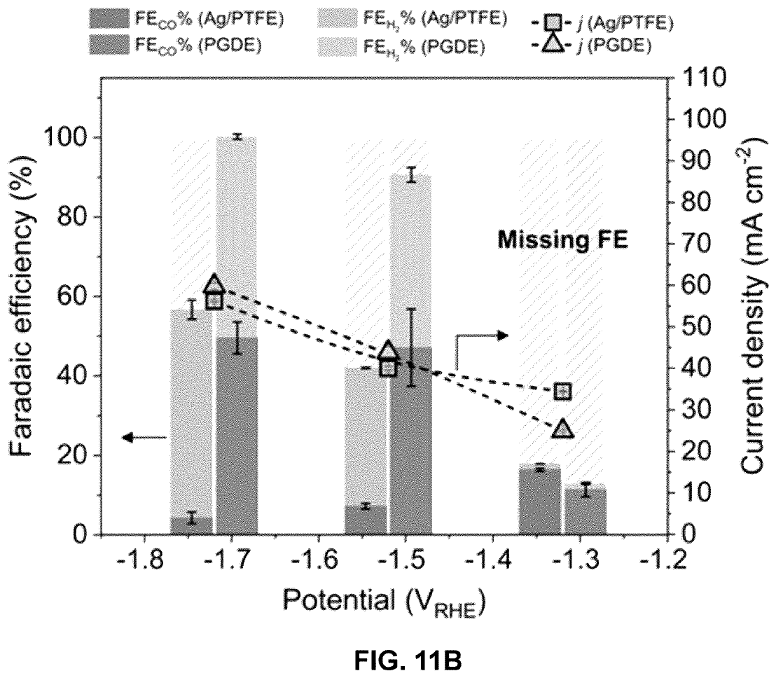

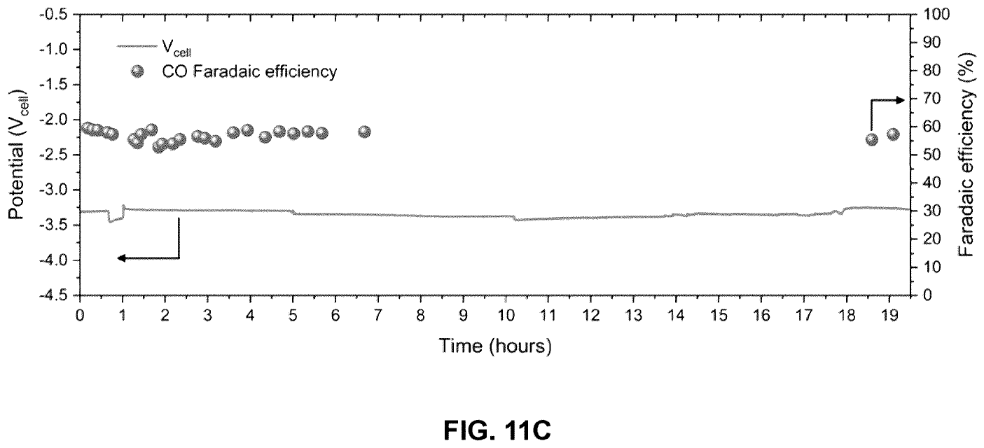

The electrochemical performance of the PGDE is further investigated by introducing O₂ and humidity to the CO₂/N₂ stream to better mimic a real post-combustion flue gas. The results show that introducing 4% O₂ to the CO₂/N₂ stream significantly impacted the electrochemical performance for the bare Ag/PTFE electrode (FIG. 11A). Missing faradaic efficiency is observed for both the PGDE and bare electrode due to the parasitic oxygen reduction reaction (ORR) at a relatively low applied potential of −1.32 V_{RHE}. (Xu, Y.; Edwards, J. P.; Zhong, J.; O'Brien, C. P.; Gabardo, C. M.; McCallum, C.; Li, J.; Dinh, C. T.; Sargent, E. H.; Sinton, D. Oxygen-Tolerant Electroproduction of C2 Products from Simulated Flue Gas. Energy Environ. Sci. 2020, 13 (2), 554-561.) Nevertheless, performance is partially retained at higher applied cathodic potentials, when introducing the capture layer, which confirms that CALF-20 has poor selectivity for O₂.

Moreover, the gas stream was further modified by introducing 100% RH to obtain a close-to-real post-combustion flue gas stream (Table 3). FIG. 11B compared the electrochemical performance of the PGDE with and without introducing humidity to the gas stream. The results indicate that the humidity slightly impacts the electrochemical performance of the Ag/PTFE with the MMM layer. Many MOF structures get saturated with water molecules at low relative humidity (RH), however, CALF-20 molecular simulations showed that adsorption kinetics are unaffected by water even at 40% relative humidity. (Dureckova, H. Robust Machine Learning QSPR Models for Recognizing High Performing MOFs for Pre-Combustion Carbon Capture and Using Molecular Simulation to Study Adsorption of Water and Gases in Novel MOFs, University of Ottawa, 2018.) This degree of water resistance in the CO₂ adsorption of CALF-20 has not been noted in other MOFs, while it has been supported by multiple experiments and simulations. (Lin, J.-B.; Nguyen, T. T. T.; Vaidhyanathan, R.; Burner, J.; Taylor, J. M.; Durekova, H.; Akhtar, F.; Mah, R. K.; Ghaffari-Nik, O.; Marx, S.; Fylstra, N.; Iremonger, S. S.; Dawson, K. W.; Partha, S.; Hovington, P.; Rajendran, A.; Woo, T. K.; Shimizua, G. K. H. A Scalable Metal-Organic Framework as a Durable Physisorbent for Carbon Dioxide Capture. Science. 2021, 1469 (December), 1464-1469; Dureckova, H. Robust Machine Learning QSPR Models for Recognizing High Performing MOFs for Pre-Combustion Carbon Capture and Using Molecular Simulation to Study Adsorption of Water and Gases in Novel MOFs, University of Ottawa, 2018.) The hydrophobicity of the CALF-20, yet elevated CO₂-phillicity, is enabled by its distinctive pore structure. A key feature of CALF-20 is the absence of strong binding interactions for adsorbing CO₂. The lack of these strong strongly interacting functionalities in the presence of interactions between the guest molecules hinder preferential binding of H₂O. (Walton, K. S.; Millward, A. R.; Dubbeldam, D.; Frost, H.; Low, J. J.; Yaghi, O. M.; Snurr, R. Q. Understanding Inflections and Steps in Carbon Dioxide Adsorption Isotherms in Metal-Organic Frameworks. J. Am. Chem. Soc. 2008, 130 (2), 406-407; Vaidhyanathan, R.; Iremonger, S. S.; Shimizu, G. K. H.; Boyd, P. G.; Alavi, S.; Woo, T. K. Direct Observation and Quantification of CO₂ Binding within an Amine-Functionalized Nanoporous Solid. Science. 2010, 330 (6004), 650-653.)

### Example 6: Experimental Methods

### Gas Sorption

All adsorption isotherms for N₂, CO₂, CH₄, C₂H₄, and C₂H₆ are obtained using an Accelerated Surface Area & Porosimetry System 2020 (ASAP) supplied by Micromeritics Instruments Inc. Temperature control is achieved through use of liquid N₂ (77.35 K) or a Thermo NESLAB RTE 7 plus Chiller (263.35 K-273.35 K). For samples run using liquid N₂, an isothermal jacket was employed on the sample tube and Po tube to ensure constant cryogenic level to compensate for evaporation. Free space measurements are performed at 77 K and 298 K using He (99.9999%).

Typical sample preparation involves loading sample (˜100 mg) into a dry and pre-weighed glass analysis tube using a glass funnel. The sample is then placed on the ASAP desorption port where it is heated from ambient temperature to 60° C. at a rate of 2° C. min⁻¹ and held for 2 hours. The pressure is also reduced at 1.3 mbar s⁻¹ until 10-3 mbar is achieved. The second stage of heating to the desired activation temperature is obtained by heating at a rate of 2° C. min⁻¹ and holding at the temperature (typically for 8-12 hours) until the outgassing rate is <3 mbar h⁻¹. The sample is then cooled and backfilled with N₂ before being weighed and transferred to the analysis port.

Aside from assigning a type to the general shape of an isotherm, a significant amount of information can be extracted from an isotherm via the extent of uptake. The magnitude of the uptake is a strong indicator of the degree of porosity and details regarding the porosity can be extracted by applying the proper model. As long as the proper model is applied and the limitations acknowledged, useful information such as surface area, pore size, and heat of adsorption can be extracted for comparison between adsorbents.

### Fourier-Transform Infrared Spectroscopy (FTIR).

Fourier-transform infrared spectroscopy (FTIR) spectra of the catalysts are collected on a Perkin Elmer Frontier FTIR spectrometer. Each spectrum is collected with a resolution of 4 cm⁻¹ with an accumulation of 32 scans.

### Scanning Electron Microscopy (SEM)

Morphology and surfaces were observed using a field-emission scanning electron microscope (FEI Quanta 400) with 20 KV accelerating voltage. An energy dispersive (EDS) detector was utilized to understand the elemental distribution, and atomic mapping was examined using the TEAM™ Analysis System EDS software suite (Eden Instruments).

### Reaction Product Analysis and Calculation

The electrolytic reactions are run for at least 100 s before collecting the gaseous product samples for analysis. The liquid product of the electrochemical reaction is analyzed using a Bruker AVANCE III 600 MHz nuclear magnetic resonance (NMR) spectrometer. The gaseous products of the CO₂ reduction, i.e., H₂ and CO, are analyzed by gas chromatography (PerkinElmer Clarus 680) employing Carboxen-1000 and Molecular Sieve 5A packed columns. The gas chromatograph was equipped with a flame ionization detector (FID) and a thermal conductivity detector (TCD). The carrier gas inside the column was argon (Air Liquide, 99.999%). The partial current density (jₓ) of products is calculated according to the equation:

$${j}_{x} = \frac{{n}_{x} {v}_{g a s} {c}_{x} F}{{V}_{m}}$$

where iₓ is the partial current for product x, iₜₒₜₐₗ is the total current during the reaction, nₓ is the number of electrons transferred to produce 1 mole of x, v_{gas} is the flowrate of CO₂, cₓ is the concentration of the product x detected by the GC, F is the Faraday constant (96,485 C/mol) and Vₘ represents the unit molar volume at Standard Laboratory Conditions (SLC) (298.15 K and 100 KPa), which is 24.5 L/mol. The Faradaic efficiency of the gas products was evaluated using the following equation:

$${FE}_{x} \% = \frac{{j}_{x}}{{j}_{total}} \times 100$$

The geometric area of the electrode, i.e., 1 cm², was used for all the experimental data presented herein, e.g., current densities and/or Faradaic efficiencies.

1.-41. (canceled)

42. A permselective gas diffusion electrode (PGDE) for electrocatalytic reduction of CO₂ and/or CO which comprises:
a mixed matrix membrane (MMM) which exhibits selective adsorption of CO₂ and/or CO relative to N₂, O₂, water vapor or any combination thereof having a gas-feed side and a reaction side; and
an electrically conductive CO₂ and/or CO reduction catalyst layer in fluid communication with the reaction side of the MMM, wherein the gas-feed side of the MMM is in fluid communication with a CO₂-containing gas and/or a CO-containing gas.

43. The PGDE of claim 42, wherein the reduction catalyst layer provides an electrode of the PGDE.

44. The PGDE of claim 42, further comprising a gas diffusion layer having a gas-feed side and a reaction side, wherein the MMM is provided as a layer or coating on the gas-feed side of the gas diffusion layer, and the reduction catalyst is provided as a layer or a coating on the reaction side of the gas diffusion layer.

45. The PGDE of claim 42, wherein the MMM comprises an inorganic or organic or organic-inorganic filler of intrinsic nanopores (FIN) that exhibits CO₂-selective adsorption and/or CO-selective adsorption uniformly dispersed in a suitable polymer matrix.

46. The PGDE of claim 45, wherein the FIN is selected from the group consisting of an MOF, COF, zeolite and carbonaceous material.

47. The PGDE of claim 46, wherein the FIN is an MOF.

48. The PGDE of claim 47, wherein the MOF is a Zn-MOF.

49. The PGDE of claim 46, wherein the MOF is CALF-20.

50. The PGDE of claim 42, wherein the reduction catalyst is an MOF, a metal, a metal alloy or a metal oxide.

51. The PGDE of claim 42, wherein the reduction catalyst is CALF-20 or ZIF-8.

52. The PGDE of claim 42, wherein the reduction catalyst is selective for formation of CO from CO₂.

53. The PGDE of claim 52, wherein the reduction catalyst is Ag, Pb or Au.

54. The PGDE of claim 42, wherein the reduction catalyst is a copper catalyst selected from the groups consisting of Ag-doped Cu, Ag—Ru co-doped Cu, Pd-doped Cu, Cu—Ag, ordered Cu-PD, Cu—Au, Cu single-atomic catalyst, Cu—Cu dual-atomic catalyst, triangular-shaped Cu nanosheet, fragmented Cu, Cu nanocavity hierarchical Cu, and oxide-derived Cu.

55. The PGDE of claim 42, wherein the polymer matrix is polydimethylsiloxane (PDMS), polyoctomethylsiloxane (POMS), polyimide (PI), polyethersulfone (PES), polysulfone (PSF), sulfonated fluoropolymers, block copolymers (PI-PDMS) or copolymers.

56. An alkaline flow cell or membrane electrode assembly for CO₂ and/or CO reduction which comprises the PGDE of claim 42.

57. A method for electrocatalytically reducing CO₂ which comprises separating CO₂ from a CO₂-containing gas employing a PGDE of claim 42 and contacting the separated CO₂ with a CO₂ reduction catalyst in an alkaline flow cell or membrane electrode assembly for CO₂ reduction.

58. The method for electrocatalytically reducing CO₂ of claim 57, wherein CO is the predominate product of CO₂ reduction and catalytically reducing the electrocatalytically generated CO is further reduced catalytically to produce methane, formate or C₂₊ products.

59. The method of claim 55, wherein CO product of electrocatalytic CO₂ reduction is further electrocatalytically reduced in an alkaline flow cell or membrane electrode assembly for CO reduction.

60. A method for electrocatalytically reducing CO which comprises separating CO from a CO-containing gas employing a PGDE of claim 42 and contacting the separated CO with a CO reduction catalyst in an alkaline flow cell or membrane electrode assembly for CO reduction.

61. A method for reduction of CO₂ which comprises separating CO₂ from a CO₂-containing gas employing a CO₂-selective PGDE wherein CO is the predominate product of CO₂ reduction and electrocatalytically reducing the electrocatalytically generated CO in an alkaline flow cell or membrane electrode assembly for CO reduction comprising a CO-selective PGDE of claim 42.
